(19) United States
(12) Patent Application Publication
(10) Pub. No.: US 2026/0209102 A1
(43) Pub. Date: Jul. 23, 2026

(54) LASER GLASS WELDING OF OPTICAL COMPONENTS USING FIDUCIALS

(71) Applicant: INTUITIVE SURGICAL OPERATIONS, INC., Sunnyvale, CA (US)

(72) Inventors: Mudabbir Badar, Christiansburg, VA (US); Charles Jarrett, Blacksburg, VA (US); Eric Sanborn, Blacksburg, VA (US)

(21) Appl. No.: 19/458,179

(22) Filed: Jan. 23, 2026

Related U.S. Application Data
(60) Provisional application No. 63/748,590, filed on Jan. 23, 2025.

(51) Int. Cl. C03B 23/22; G02B 27/32; G02B 27/62

(52) U.S. Cl. CPC C03B 23/22; G02B 27/32; G02B 27/62

(57) ABSTRACT

Techniques are disclosed herein for laser glass welding optical components to a substrate using fiducial markers to create optical devices. An example optical device disclosed herein comprises a substrate and an optical system. The substrate includes a component surface, a back surface opposite the component surface, and a plurality of fiducial markers within the substrate between the component surface and back surface. The optical system is configured to process light. The optical system includes a plurality of optical components on the component surface of the substrate, and each optical component is aligned to a respective fiducial marker.

### CROSS-REFERENCE TO RELATED APPLICATION

This application claims priority to U.S. Provisional Patent Application No. 63/748,590, entitled “Laser Glass Welding of Optical Components Using Fiducials,” filed on Jan. 23, 2025, the disclosure of which is hereby incorporated herein by reference.

### FIELD OF THE DISCLOSURE

The present disclosure generally relates to assembling components of an optical system, such as by laser welding, and, more specifically, to writing and using fiducials within a substrate to align optical components on the substrate.

### BACKGROUND OF THE DISCLOSURE

Optical components of various types may be combined to form optical systems that process light. The behavior of light that propagates through an optical system depends not only the types of optical components which the light encounters within the optical system, but also the relative positions and orientations of the optical components. Assembling such optical systems typically includes positioning and bonding of these optical components according to a specified design. It is desirable to achieve precise alignment and bonding of components within an assembly.

### SUMMARY

In one example, the techniques described herein relate to an optical device, including: a substrate including: a component surface; a back surface opposite the component surface; and a plurality of fiducial markers within the substrate between the component surface and back surface; and an optical system configured to process light, the optical system including a plurality of optical components on the component surface of the substrate, each optical component being aligned to a respective fiducial marker.

In another example, the techniques described herein relate to a method for manufacturing an optical device, including: generating image data of a substrate of the optical device; writing a plurality of fiducial markers to the substrate using a laser based on the image data, the plurality of fiducial markers indicating a physical layout of an optical system including a plurality of optical components on a component surface of the substrate; and determining that an optical component of the plurality of optical components is aligned with a fiducial marker of the plurality of fiducial markers based on the image data.

In yet another example, the techniques described herein relate to a system for aligning an optical device, the system including: a laser for writing a plurality of fiducial markers to a substrate, the plurality of fiducial markers indicating a physical layout of an optical system including a plurality of optical components on a component surface of the substrate; an imaging system configured to generate image data of the substrate; and a controller configured to: cause the laser to write the plurality of fiducial markers to the substrate based on the image data; and determine that an optical component of the plurality of optical components is aligned with a fiducial marker of the plurality of fiducial markers based on the image data.

### BRIEF DESCRIPTION OF THE DRAWINGS

FIG. 1 schematically illustrates a perspective view of an example of a fiducial writing system.

FIG. 2 schematically illustrates a perspective view of an example laser welding system.

FIG. 3A illustrates a side view of an example fiducial writing process.

FIG. 3B is a top-down view of a completed set of fiducial markers within a substrate that were written based on a defined starting point.

FIG. 3C is an example cross-sectional view of a completed set of fiducial markers at two different distances from a back surface of a substrate and corresponding proximity/distance to a component surface of the substrate.

FIG. 4A schematically illustrates an optical component laser welding process for a substrate that is guided/aligned using fiducial markers.

FIG. 4B is a top-down view of an optical component alignment.

FIG. 4C is a cross-sectional view of the optical component alignment illustrated in FIG. 4B.

FIG. 4D is a top-down view of an example optical system aligned using fiducial markers, with several optical components being misaligned with their respective fiducial markers to tune the example optical system.

FIG. 5A schematically illustrates a datum writing process for aligning optical components on a substrate.

FIG. 5B is a top-down view of an optical component alignment using various datum written in multiple different locations of a substrate.

FIG. 6A schematically illustrates an optical component alignment and welding process using an edge of the substrate as a datum.

FIG. 6B is a top-down view of an alignment of multiple optical components using one or more edges of the substrate as the datum.

FIG. 7 is a flow chart of an example method for writing fiducial markers indicating a physical layout of an optical system in a substrate to align optical components on the substrate.

FIG. 8 is a flow chart of an example method for writing datum in a substrate to align optical components on the substrate.

Corresponding reference characters indicate corresponding parts throughout the several views. Elements in the drawings are not necessarily drawn to scale. The configurations shown in the drawings are merely examples and should not be construed as limiting in any manner.

### DETAILED DESCRIPTION

The disclosure generally relates to aligning and welding optical components on a glass substrate, leveraging the capabilities of an ultra-short pulse (USP) laser to write fiducials (also referenced herein as “fiducial markers”) within the glass substrate and thereby avoid creating surface deformations that could impact optical component contact with the substrate. As referenced herein, “writing” fiducial markers generally references a laser beam/pulse interacting with a substrate (e.g., a glass substrate) to heat and thereby alter the refractive index of a portion of the substrate.

Fiducials are created using a USP laser that changes the refractive index of the glass due to heat accumulation caused by the energy released by the ultrafast laser pulses.

The laser-written lines are sharp with a thickness of a few tens of microns and are normally written within the substrate (e.g., in the middle or offset from the middle but not at the surfaces) so there is a minimal or negligible impact on any exterior surfaces. Once the fiducials of an optical system are written, optical components are aligned in their respective places before attachment. In some examples, the attachment of optical components to the substrate in positions corresponding to fiducials is via laser welding. In some examples, the laser welding of optical components to the substrate in positions corresponding to fiducials may be performed using the same USP laser used to write the fiducials. Alignment may be accomplished using machine vision guidance of a multi-axis robotic manipulator.

The techniques described herein can ensure the exact placement of the component in x and y coordinates (e.g., along x-axes and y-axes described herein) while correct z-axis (depth) positioning in laser welding may be achieved by close contact between the two surfaces (component and component surface of glass substrate). The present techniques also help correct yaw angle placement of optical components by comparing the edges of the components with fiducial lines, while pitch angle and roll angle corrections may leverage a displacement sensor (also referenced herein as a “depth” sensor) to measure the pitch/roll angles between the substrate and the component when the component is at the correct x and y coordinates.

Moreover, the present techniques also enable the use of cameras and camera systems having a smaller field of view during the component alignment process, as compared to many existing systems/techniques. These existing alignment systems often rely on a component's edges or other large features as fiducials, such that a larger field of view is often necessary to capture these features. A larger field of view generally reduces the system's magnification and, consequently, its precision. By contrast, a smaller field of view camera can generally provide greater magnification, which allows the present techniques to identify and align the optical components with the fiducials with higher precision than existing techniques typically achieve. Further, cameras with smaller fields of view and higher magnification capabilities are often more compact than those required to cover larger areas with lower magnification, which can correspondingly lead to more compact physical setups that are particularly advantageous in space-constrained manufacturing environments.

The fiducial writing process includes calibrating a laser 3D actuation system (e.g., incorporated in a controller) by registering associations between the laser's position and images captured by an imaging system (e.g., one or more cameras or other imaging devices) to the 3D actuation system. The laser 3D actuation system can then control the laser's 3D position based on these associations in combination with newly captured images while writing fiducials. In particular, the 3D actuation system utilizes z-axis (depth) motion to focus the laser beam within the substrate at the required depth. The 3D actuation system also utilizes x-axis and y-axis motion of the USP laser or focusing components to write the fiducials defining the layout of the optical components. The fiducials generally represent the physical layout of an optical network/system, and in some examples, the fiducials indicate the exact size and arrangement of some/all network components.

Alternatively, aligning the optical components can be achieved by writing datum in x and y coordinates on the substrate using the USP laser. The datum serves as a starting point, from which, optical components may be placed on the substrate based on distance measurements using the imaging system. The imaging system may be calibrated to provide precise x and y coordinate measurements based on pixel size. In some examples, the calibration is based on pixel counts between the endpoints of a line written in the substrate of a known length. The USP laser writes a line in the x and y dimensions on a substrate and the imaging system captures images of the line and the component edge(s) to determine where to move the component for accurate positioning on the substrate. In some examples, the x-y datum can be the edges of the substrate, which minimizes the need to write datum lines in the substrate with the USP laser.

The imaging system is generally positioned above the substrate to capture images of the components and fiducials during alignment, and the laser is also positioned above the substrate to write the fiducials at the necessary depth within the substrate. The imaging system depth of focus can be limited, such that fiducials positioned near the bottom surface of the substrate may not appear in focus simultaneously with optical components being aligned, leading to misalignments. Writing fiducials within the substrate near the welding surface (along the z-axis) allows the images produced by the imaging system to include both in-focus fiducial lines and in-focus component edges during alignment, which provides for accurate image-guided component alignment and placement. In certain embodiments, the USP laser operates at approximately 10 millimeters (mm) per second or faster to write the fiducials in the substrate.

With the written fiducials, the alignment system positions the components within their respective places on the substrate for attachment. For example, the alignment system utilizes a robotic arm or a 6D stage to hold the component. Optical components are brought to their designated place defined by the fiducials (e.g., one by one) and are attached to the substrate. A camera that captures image data of the substrate from either side (e.g., same side of the substrate as the USP laser) of the substrate is used to confirm the proper placement of the component on the substrate. For example, the camera output may be analyzed by a control system using machine vision algorithms that perform edge detection and/or other suitable machine vision (MV) algorithms to ensure that the components are placed in alignment with respective fiducials.

The alignment system generally captures continuous visuals of the fiducials and the corresponding optical components to ensure correct positioning of the component along the x-axis, y-axis, and yaw angles. The alignment system may ensure correct alignment in the remaining three degrees of freedom (e.g., z-axis, roll angle, and pitch angle) using a displacement sensor which can measure the distance of the optical component from the glass substrate and the angle slope in y and z coordinates.

When the optical components are aligned with the respective fiducial marker and/or are otherwise appropriately positioned on the substrate (e.g., adjusted to tune the optical system) the optical component is generally welded to a component surface of the substrate. Welding two components via laser welding, such as by using a USP laser, may overcome potential drawbacks of other attachment mechanisms, such as weak bonds, aging, slow processing, high cost, and relatively tight tolerances on flatness and cleanliness of the surfaces of the components. Laser welding may avoid use of additional material that may be hydroscopic, use of additional material that may have a relatively high coefficient of thermal expansion, or use of a material that may be absorptive. Laser welding may optionally be used in combination with any other attachment mechanism.

In laser welding of components, optical elements may focus the pulsed laser to a relatively small area at an interface between the adjacent surfaces of the components. The laser welding may utilize a USP laser beam focused at a very small area. With each pulse (e.g., generally on the order of femtoseconds to one picosecond), the laser pulse generates some heat due to absorption. The laser may have a relatively high repetition rate, which may allow heat to accumulate locally (e.g., before the heat may dissipate) and raise the temperature high enough to melt the components (e.g., glass) locally. After the pulsed laser has been applied, the melted material may cool and solidify, thereby forming a bond between the adjacent surfaces of components. This type of laser welding is also referred to herein as “direct” laser welding because the laser is used to weld surfaces of adjacent components without using an adhesive (e.g., that is cured by laser or other light) or other type of separate attachment material. The movement of the laser and/or optical elements may translate the focus of the laser along the interface between the adjacent optical elements to form a bond over a larger surface area, such as in corners of a surface, around a perimeter of the surface, or at discrete locations that are distributed over a surface area of the surface. Away from the interface, such as in an interior of the components or outside the components, the heat accumulated during the welding process is sufficiently localized at the weld site/spot and dissipates quickly enough outside of the weld site/spot to avoid melting of the components, or damaging any other components, such as electronic components or organic materials.

Examples discussed herein relate to configurations and geometries of optical assemblies that may allow optical components to be positioned in space with multiple positional and orientational degrees of freedom, while allowing the optical components to be in contact with adjacent components (e.g., subcarriers, pedestals, etc.) that facilitate positioning of the optical components in a manner that is suitable for laser welding. Examples of suitable optical components may include optical fibers within ferrules, lenses, objective elements, actuatable optical elements, windows, mirrors, dichroic mirrors, focusing elements, filters, beam splitters, sensors, V-groove fiber arrays, photonic integrated circuits (PIC), planar integrated circuits (PLC), and others. In the figures that follow, some of the optical components are depicted as being rectangular or having a rectangular cross section or a rectangular perimeter; it will be understood that any other suitable shapes may also be used.

To form the laser weld, additional optical components (not shown) may direct a pulsed laser beam through a specified thickness of material to a focus at an interface between two contacting surfaces of the components.

In the following discussion, for simplicity, the substrate has a fixed position with respect to a coordinate system {x, y, z}, while other components, such as pedestals and optical components, are positioned with respect to the substrate and the coordinate system. Moreover, for simplicity, the x and y coordinates described herein define a plane that is co-planar with a component surface and/or a back surface of a substrate, and the z coordinates described herein are correspondingly normal to (e.g., into/out of) the plane and substrate surfaces.

In the following discussion, for simplicity, various portions of various components are referred to as surfaces. A surface of a component, as discussed below, may be in contact with and/or bonded to a surface of another component. It will be understood that the surface at which contact and/or bonding occurs may be only a portion of a side of a component. In some examples, a surface may be entirely flat. In other examples, a surface may include curves or other non-flat features.

In accordance with the description above and elsewhere herein, the techniques of the present disclosure provide enhanced precision in the placement of optical components.

Namely, through the innovative use of fiducial markers written directly into the substrate by a USP laser, the present techniques enable the precise positioning of components without the need for traditional adhesives or mechanical fixtures. These techniques not only circumvent the drawbacks associated with such materials, including thermal expansion and moisture absorption, but also achieve micron-level accuracy in optical component placement. The ability to maintain such high levels of precision improves the performance of the resulting optical systems, particularly in applications with stringent alignment tolerances.

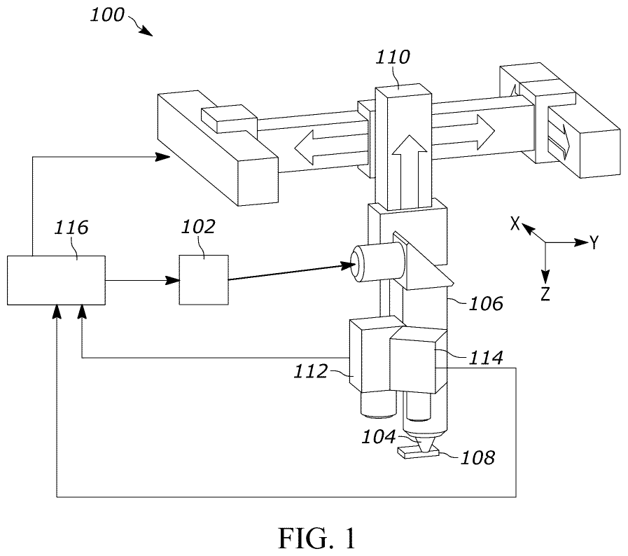

Turning to the figures, FIG. 1 schematically illustrates a perspective view of an example of a fiducial writing system 100. The fiducial writing system 100 includes a laser light source 102 or, simply, a laser 102. The laser light source 102 may produce a high-energy beam of laser light 104 or, simply, a laser beam 104 that is used to write fiducial markers within a substrate 108. In some examples, the laser light source 102 may be an ultrafast pulsed laser light source. The ultrafast pulsed laser may emit optical pulses with a duration of 0.01, 0.02, 0.05, 0.1, 0.2, 0.5, 1, 2 picoseconds or any other suitable duration. The laser light source 102 may be a CO₂ laser, a neodymium-doped yttrium aluminum garnet (Nd:YAG) laser, a fiber laser, a semiconductor laser, or another suitable laser.

The fiducial writing system 100 includes beam-focusing optics 106. The beam-focusing optics 106 may guide the laser beam 104 from the laser light source 102 to the point within the substrate 108 where the fiducials are to be written/produced. The beam-focusing optics 106 may include mirrors, lenses, and/or other optical components to focus and direct the laser beam 104. For example, the beam-focusing optics 106 may include an objective lens that brings the laser beam 104 to a sharp focus at a specified location in space. As another example, the beam-focusing optics 106 may include a turning mirror that may direct the laser beam 104 from the laser light source 102 to the objective lens. The beam-focusing optics 106 may be enclosed, or may include light baffles, to block stray light from the laser beam 104 for the safety of operators and others in proximity to the fiducial writing system 100.

The fiducial writing system 100 includes a beam positioner 110. The beam positioner 110 may reposition the laser beam 104. In some examples, the beam positioner 110 may reposition the laser beam 104 with three degrees of freedom, including: position along the x-axis, position along the y-axis, and position along the z-axis. In some examples, the beam positioner 110 may adjust an angle of incidence of the laser beam 104.

The fiducial writing system 100 includes a first position sensor 112. The first position sensor 112 may measure (directly or indirectly) positions in the z-direction of the substrate 108, with respect to the beam-focusing optics 106. The first position sensor 112 may also generate position data that corresponds to the position in the x, y, and/or z-directions of the substrate during the fiducial writing process, with respect to the beam-focusing optics 106. In certain embodiments, the first position sensor 112 may only generate position data corresponding to the position in only the z-direction of the substrate during the fiducial writing process relative to the beam-focusing optics 106. The first position sensor 112 may transmit this position data to a controller 116, which may use this position data to calibrate the positioning of the beam-focusing optics 106 for writing the fiducial markers and/or for subsequent optical component placement and welding onto the substrate 108. The first position sensor 112 may include a camera, an interferometer, a time-of-flight sensor that measures a round-trip time of light from the first position sensor 112 to the substrate 108 and back to the first position sensor 112, and/or a suitable sensor using other suitable measuring technique.

The fiducial writing system 100 optionally includes a second position sensor 114. The second position sensor 114 may capture image data of the fiducial writing process from the same surface of the substrate 108 as the first position sensor 112. The second position sensor 114 may transmit this image data to the controller 116, which may correlate the image data with the position data from the first position sensor 112 to further calibrate the positioning of the beam-focusing optics 106 for writing the fiducial markers and/or for subsequent optical component placement and welding onto the substrate 108. Namely, the controller 116 may calibrate the offset between the image data captured by the second position sensor 114 and the laser beam output from the beam-focusing optics 106, similar to the calibration performed by the controller 116 between the position data captured by the first position sensor 112 and the laser beam output from the beam-focusing optics 106. The second position sensor 114 may include a camera, an interferometer, a time-of-flight sensor that measures a round-trip time of light from the second position sensor 114 to the substrate 108 and back to the second position sensor 114, and/or a suitable sensor using other suitable measuring technique.

The fiducial writing system 100 includes a controller 116. The controller 116 may receive the data from the first position sensor 112 and the second position sensor 114. The controller 116 may control at least one of the laser light source 102 and the beam positioner 110 in response to the received data.

It should be noted that the fiducial writing system 100 is only one possible fiducial writing system configuration, and many other configurations are possible. For example, the laser beam 104 may, in some examples, be positioned with six degrees of freedom in addition to focus with respect to the optical device or assembly being made. The fiducial writing system 100 may include beam shaping optics to shape the beam 104 at the point of writing the fiducial markers within the substrate 108. Additionally, or alternatively, the fiducial writing system 100 may include power sensors, temperature sensors, and/or any other suitable sensors communicatively connected to the controller 116. The controller 116 may control at least one of the laser light source 102 and the positioner 110 at least in part in response to received sensor data.

The fiducial writing system 100 may include or be communicatively connected with an assembly system configured to manipulate and/or otherwise position components under the beam-focusing optics 106. For example, the fiducial writing system 100 may include a robotic arm with a substrate holder and/or manipulator to position the substrate under the beam-focusing optics 106 to have fiducial markers written therein. The manipulator may include a gripper, a vacuum holder, or any other suitable device for holding the substrate and/or any other suitable component(s).

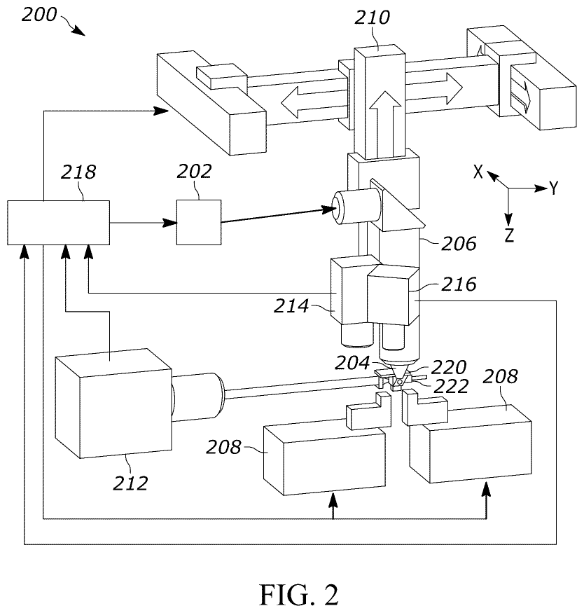

FIG. 2 schematically illustrates a perspective view of an example laser welding system 200 that may be used to manufacture an optical system. The example laser welding system 200 may include many of the same components as the example fiducial writing system 100. In certain embodiments, the laser light source 202 of the example laser welding system 200 is the same laser as the laser light source 102 of the example fiducial writing system 100. In other words, the laser light source 202 may be used both to write the fiducial markers in the substrate 220, as well as welding the optical components to the substrate 220 to manufacture an optical system comprised of the optical components. Moreover, any of the beam-focusing optics 206, the positioner 210, the first position sensor 214, the second position sensor 216, and/or the controller 218 illustrated in FIG. 2 may be the same components as illustrated as part of the example fiducial writing system 100 of FIG. 1. The substrate 220 illustrated in FIG. 2 represents the substrate 108 of FIG. 1 after the fiducial writing process, such that the substrate 220 includes one or more fiducial markers written by the example fiducial writing system 100.

The laser light source 202 generally produces a high-energy laser beam 204 that is used to produce laser welds between adjacent surfaces in an optical assembly (e.g., between a component surface of the substrate 220 and a surface of an optical component). In some examples, the laser light source 202 may be an ultrafast (e.g., picosecond, femtosecond, etc.) pulsed laser light source, and may be a CO₂ laser, a Nd:YAG laser, a fiber laser, a semiconductor laser, or another suitable laser.

The laser welding system 200 includes beam-focusing optics 206, which guide the laser beam 204 from the laser light source 202 to the point of welding. The beam-focusing optics 206 may include mirrors, lenses, and other optical components to focus and direct the laser beam 204. For example, the beam-focusing optics 206 may include an objective lens that brings the laser beam 204 to a sharp focus at a specified location in space and/or a turning mirror that directs the laser beam 204 from the laser light source 202 to the objective lens.

The laser welding system 200 includes a part positioner 208. The part positioner 208 holds the materials (e.g., components) being welded in place during the welding process. The part positioner 208 may include one or more fixtures, clamps, or robotic arms. The part positioner 208 may move an optical assembly to position the optical assembly with respect to the sharp focus of the laser beam 204. In particular, the part positioner 208 may hold individual optical components (e.g., optical components 222) in positions on the substrate 220 where the optical components are to be welded and may move the optical components in at least the z-direction to ensure there is high-quality contact between the surface of the substrate 220 and a surface of the optical components. The part positioner 208 may perform its positioning with six degrees of freedom, including: position along an x-axis, position along a y-axis, position along a z-axis, rotation about the x-axis, rotation about the y-axis, and rotation about the z-axis.

The laser welding system 200 includes a beam positioner 210. The beam positioner 210 may reposition the laser beam 204, and as a result may perform the physical adjustments necessary (e.g., moving the laser head in the z-direction) to calibrate the laser beam focus. In some examples, the beam positioner 210 may reposition the laser beam 204 with three degrees of freedom, including: position along the x-axis, position along the y-axis, and position along the z-axis. In some examples, the beam positioner 210 may adjust an angle of incidence of the laser beam 204.

The example laser welding system 200 includes an alignment camera 212 that is generally configured to align and monitor alignment of the optical device being constructed on the substrate 220. The alignment camera 212 may provide for optical beam alignment, such as to facilitate checking of beam collimation, beam size and position of the beam (in x- and y-axes) to align the beam used by the optical device being constructed on the substrate 220. The alignment camera 212 may generate image data of the optical beam and/or materials to be welded.

In certain embodiments, the alignment camera 212 may capture a video image of the materials being welded in real time, or near-real time. For example, the beam-focusing optics 206 may include a beam splitter that allows the alignment camera 212 to capture image data that is coaxial with, at an angle to, from the side of, or directly below the welding laser beam 204. In these embodiments, the laser beam 204 may also be attenuated to avoid damaging the alignment camera 212.

In some examples, the alignment camera 212 may generate part position data that corresponds to a location of the materials being welded. In some examples, the alignment camera 212 may be used to visualize the far field beam formed by the optics to be welded together. For example, when welding together a device that collimates light, the alignment camera 212 may be used to confirm that the beam is collimated and pointed in the correct direction relative to features on the optical device or assembly being made.

The example laser welding system 200 includes a first position sensor 214. The first position sensor 214 may measure (directly or indirectly) positions in the z-direction of the materials being welded, with respect to the beam-focusing optics 206. The first position sensor 214 may generate position data that corresponds to the position in the x, y, and/or z-directions of the materials being welded, with respect to the beam-focusing optics 206. The first position sensor 214 may include a camera, an interferometer, a time-of-flight sensor that measures a round-trip time of light from the first position sensor 214 to a reflecting element on the part positioner 208 and back to the first position sensor 214, and/or a suitable sensor using other suitable measuring technique. The first position sensor 214 may be used to confirm parts are in the correct location as well as confirm proper contact between surfaces prior to welding.

The example laser welding system 200 optionally includes a second position sensor 216. The second position sensor 216 may capture image data of the laser welding process from a same surface of the substrate 220 as the first position sensor 214. In particular, the second position sensor 216 may capture image data indicating the alignment of one or more of the optical components 222 with a corresponding fiducial marker within the substrate 220. The sensor 216 may transmit this image data to the controller 218, which may correlate the image data with the position data from the first position sensor 214 to, for example, cause the part positioner 208 to adjust an orientation (roll, pitch, and/or yaw angle) and/or an x-y-z coordinate position of the optical component 222 to thereby bring the component 222 more in-line with the corresponding fiducial marker. The second position sensor 216 may include a camera, an interferometer, a time-of-flight sensor that measures a round-trip time of light from the second position sensor 216 to the substrate 220 and back to the second position sensor 216, and/or a suitable sensor using other suitable measuring technique.

The example laser welding system 200 includes a controller 218. The controller 218 may receive the data from the alignment camera 212, the first position sensor 214, and/or the second position sensor 216. The controller 218 may control at least one of the laser light source 202, the part positioner 208, and/or the beam positioner 210 in response to the received data.

It should be noted that the example laser welding system 200 is only one possible laser welding system configurations, and many other configurations are possible. For example, the laser beam 204, the beam-focusing optics 206, the first position sensor 214, and/or the second position sensor 216 may, in some examples, be positioned with six degrees of freedom to focus the laser beam 204 and/or the sensors 214, 216 with respect to the optical device or assembly being made. The laser welding system 200 may include beam shaping optics to shape the beam 204 at the welding point. Additionally, or alternatively, the laser welding system 200 may include power sensors, temperature sensors, and/or any other suitable sensors communicatively connected to the controller 218. The controller 218 may control at least one of the laser light source 202, the part positioner 208, and/or the beam positioner 210 at least in part in response to received sensor data.

The laser welding system 200 may include or be communicatively connected with an assembly system configured to manipulate and place components into an assembly being made. For example, the laser welding system 200 may include a robotic arm with an optical component holder and/or manipulator to position the optical component being welded and maintain contact with a bonding surface at which the optical component is to be welded. The manipulator may include a gripper, a vacuum holder, or any other suitable device for holding a component.

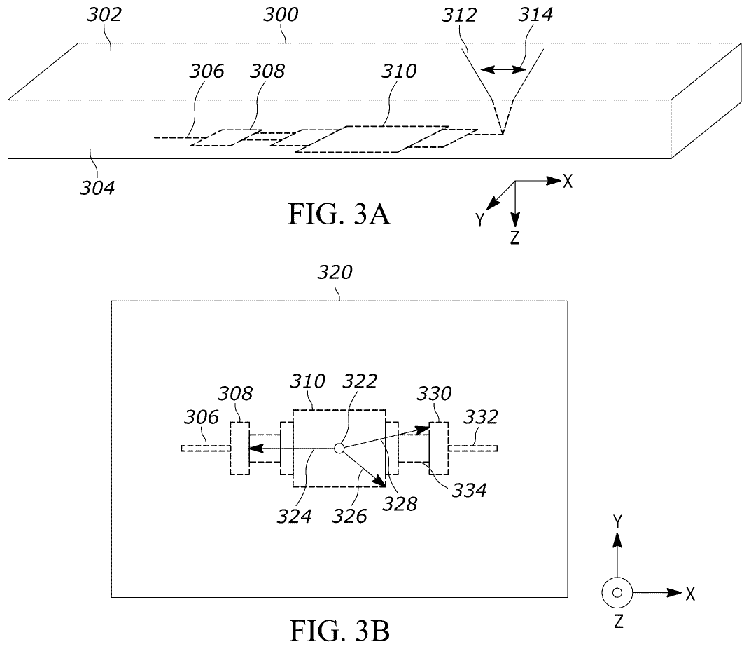

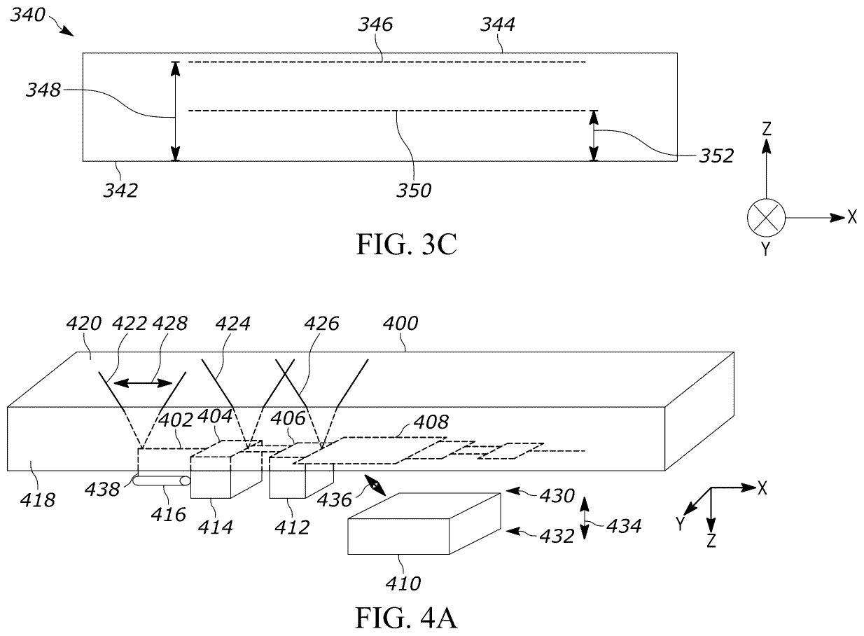

FIG. 3A illustrates a side view of an example substrate 300 during an example fiducial writing process. Generally, the shape, size, and/or layout of the fiducials may be specified in a configuration file, from which, the fiducial writing systems described herein may write the fiducials in the substrate 300. The fiducial writing process generally includes a laser light source (e.g., source 202) emitting laser beams/pulses that penetrate through a first surface 302 of the substrate 300 and interact with the substrate 300 material at a depth that may be determined, for example, by the focal length of the imaging/sensor devices (e.g., position sensors 214, 216) used to monitor the laser welding process. The controllers described herein may control the depth of the fiducial writing by changing the distance between the laser and/or the beam-focusing optics and the substrate 300, as necessary.

The second surface 304 may be a component surface of the substrate 300 where optical components are to be welded. Maintaining focus of both the optical components and the fiducial markers 306, 308, 310 may be challenging when the imaging components used for component placement have a relatively limited depth of focus. Thus, writing the fiducial markers 306, 308, 310 within millimeters or less (e.g., less than one millimeter, such as 100 microns) of the second surface 304 may enable the imaging components to maintain focus on all relevant objects (e.g., optical component edges and fiducial markers) during the laser welding process. In certain embodiments, each of the fiducials 306, 308, 310 may be written approximately in the middle of the substrate (e.g., between the first surface 302 and the second surface 304) to avoid impacting any exterior surfaces of the substrate 300. However, even when written to within a few millimeters or less (e.g., approximately 100 to 300 microns), the written fiducial markers 306, 308, 310 generally do not impact the exterior surfaces.

When the laser beam/pulses interact with the substrate 300 material, the surrounding material experiences increased temperatures, which changes the material's local index of refraction. These changes in refractive index create a different contrast as compared to the remainder of the substrate 300, resulting in the visible fiducial markers 306, 308, 310 illustrated in FIG. 3A. Because the fiducial markers 306, 308, 310 are created using USP laser pulses, the markers 306, 308, 310 are generally sharp with thicknesses on the order of tens of microns.

More particularly, each of the fiducial markers 306, 308, 310 may indicate the relative positioning and/or shape of an optical component. For example, the fiducial marker 306 may correspond to the desired location for a length of optical fiber that transmits a laser beam through to the optical component represented by the fiducial marker 308, which may be representative of the desired location for a lens configured to focus the laser light. The light may then pass through to the optical component represented by fiducial marker 310, which may be a beam splitter. Thus, the collection of fiducial markers 306, 308, 310, when complete, may represent an entire optical system configured to manipulate the laser light and/or otherwise perform some function with incident light. In certain embodiments, one or more of the fiducials 306, 308, 310 represent the exact size of the corresponding optical component. In some embodiments, one or more of the fiducials 306, 308, 310 may represent a portion of an outline of a corresponding optical component, such as one or more corners of the optical component, adjacent or non-adjacent edges of the component, etc.

The laser used to write each of the fiducials 306, 308, 310 may be guided along a path (e.g., by a controller) operating at approximately 10 mm per second or faster to write the fiducials 306, 308, 310 in the substrate 300. During the writing process, the laser writing beam 312 may be delivered scanned, for example, as shown by arrow 314, to write the fiducials in the substrate 300. During the writing process, the laser may be guided using image data from a position sensor (e.g., sensors 214, 216) that correlates the x-y position of the laser beam with a particular fiducial or corresponding optical component, that may be used in a subsequent laser welding process.

However, to begin the fiducial writing process, the position sensing systems and controllers described herein may designate a starting point within the substrate 300 to thereafter correlate x-y coordinate positions of the laser. As an example, FIG. 3B is a top-down view of a completed set of fiducial markers within a substrate 320 that were written based on a defined starting point 322. The substrate 320 may be the same as substrate 300/illustrated in FIG. 3A following the completion of the fiducial writing process, and the top-down view of FIG. 3B may serve to illustrate the coordinate registration and/or calibration the control/positioning systems described herein may perform as part of the fiducial writing process.

The controller may define and/or otherwise select the starting point 322 as an initial position for the laser system, and the starting point 322 may serve as a reference point for all other locations on the substrate 320 during the fiducial writing process. In particular, the controller may designate the pixel corresponding to the starting point 322 on the substrate 320 surface as (0,0) x-y coordinate position for the position sensor. As the laser and/or the beam-focusing optics are moved around to write the fiducials within the substrate 320, the controller may register the exact x-y location of the laser and the corresponding fiducial based on the pixel values corresponding to the fiducial, as indicated in image data captured by the positional sensor(s).

For example, the controller may cause the laser/optics to write a right edge of the fiducial 308 in accordance with an optical system configuration file. As the laser writes the right edge of the fiducial 308, the controller may receive image data of the edge and determine a relative location of the right edge relative to the starting point 322, as generally indicated by the arrow 324. Similarly, the controller may cause the laser/optics to write the fiducials 310 and 330 based on the configuration specified in the optical system configuration file and may similarly register the coordinate locations of the fiducials in the image data captured by the position sensor(s), indicated by arrows 326, 328. The controller and corresponding components may continue this coordinate registration for each fiducial marker 306, 308, 310, 330, 332 during the fiducial writing process until all fiducial markers indicated in the optical system configuration file have been written in the substrate 320.

It should be noted that not all marks written into the substrate 320 necessarily represent fiducial markers for optical components of an optical system. For example, one or more of the lines between fiducial marker 310 and fiducial marker 330 (e.g., line 334) may not represent the intended placement of an optical component. Instead, one or more of the marks made as part of the fiducial writing process may be artefacts of continuously firing the laser until all fiducial markers are written. Additionally, or alternatively, one or more of the marks made in the substrate may have another use outside of visually guiding the controller systems described herein to accurately position optical components on the substrate, such as indicating the intended path of light through the optical system or other suitable purposes. Further, such lines (e.g., line 334) may be eliminated by controlling the laser to turn on/off in a manner such that the laser is only on where a fiducial/optical component is required.

Regardless, when the fiducial writing process is complete, the substrate 320 includes a complete set of fiducial markers 306, 308, 310, 330, 332, and the control systems described herein have accurate coordinate locations for each fiducial marker 306, 308, 310, 330, 332. Each of these fiducial markers 306, 308, 310, 330, 332 may be at a consistent depth that is sufficient for the position sensor(s) of the welding systems described herein to maintain simultaneous focus of the optical component to be welded to the substrate and the corresponding fiducial marker.

To illustrate multiple possible depths of the fiducial markers, FIG. 3C is an example cross-sectional view of the completed set of fiducial markers 306, 308, 310, 330, 332 (referenced collectively as 346 or 350) from FIG. 3B at two different distances 348, 352 from a back surface 342 of the substrate 340 and corresponding proximity/distance to a component surface 344 of the substrate 340. The first completed set of fiducial markers 346 is proximate to the component surface 344 where one or more optical components are intended to be welded to create an optical system on the substrate 340. It should be appreciated that the two sets of fiducial markers 346, 350 illustrated in FIG. 3C are intended to illustrate multiple of the various depths at which fiducial markers may be positioned using the techniques of the present disclosure, and as such, are for the purposes of discussion only. Any given substrate (e.g., 300, 320, 340) may generally include a single set of fiducial markers at a single depth within the substrate.

The distance 348 between the completed set of fiducial markers 346 and the back surface 342 highlights that these fiducial markers 346 may be placed to enable a position sensor with a limited depth of focus to optimally maintain both the fiducial markers 346 and the corresponding optical components in focus during the laser welding process. For example, the distance 348 may be several millimeters, and/or any other suitable distance, depending on the thickness of the substrate 340. In scenarios where the position sensor depth of focus is not as limiting, the fiducial markers 350 may be written closer to the middle of the substrate 340, such that the distance 352 is significantly less than the distance 348.

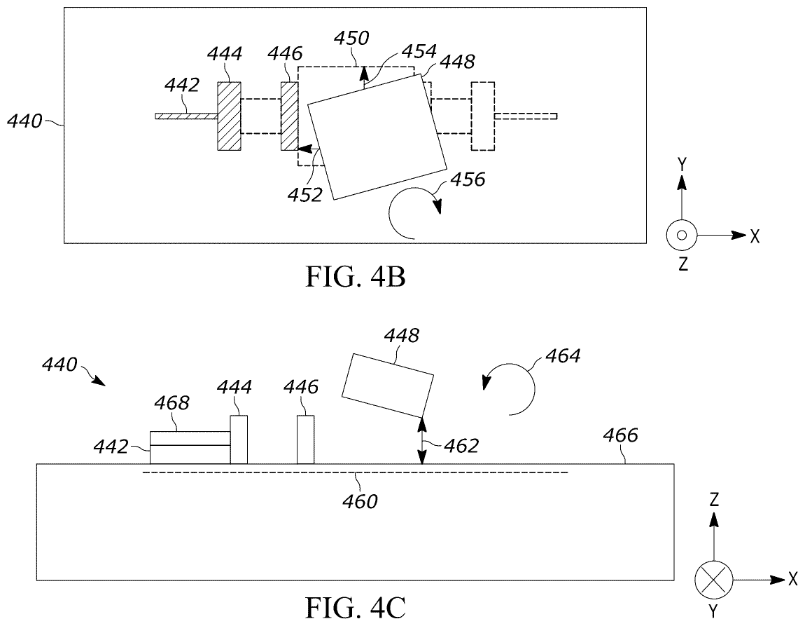

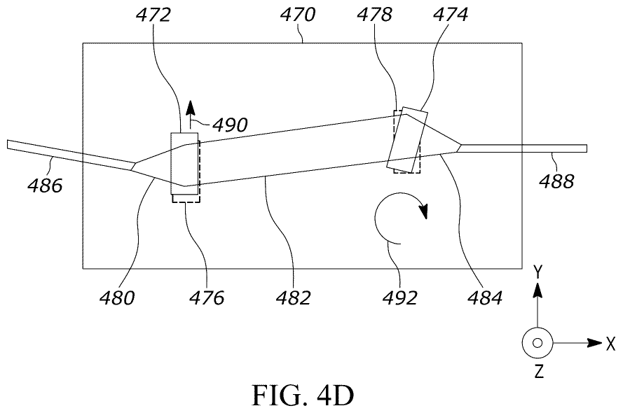

FIG. 4A schematically illustrates an optical component laser welding process for a substrate 400 that is guided/aligned using fiducial markers 402, 404, 406, and 408. This laser welding process including positioning of an optical component 410 based on the corresponding fiducial marker 408. This substrate 400 and the fiducial markers 402-408 may generally correspond to the substrate 320 and the completed set of fiducial markers 306, 308, 310, 330, and/or 332 of FIG. 3B. Moreover, the optical components 410, 412, 414, and 416 may be assembled using the example laser welding system 200.

The substrate 400 has a top surface 418 and a bottom surface 420 and is illustrated positioned upside-down in FIG. 4A, with the z-axis pointing down. The upside-down illustration is consistent with an assembly process using the laser welding system 200 with a laser welding beam 204 delivered in a downward direction through the bottom surface 420 of the substrate 400. It should be noted that the substrate 400 (and/or any other substrates illustrated herein) may extend to the right and/or to the left of the rectangle representation of the substrate 400 in FIG. 4A. For example, the optical components 410-416 comprising a portion of an optical assembly may be a sub-assembly of a larger assembly sharing the substrate 400.

During the laser welding process illustrated in FIG. 4A, the optical components 410-416 (and any subcarriers, such as 438) may be attached directly to the substrate 400 using laser welding beams 422, 424, 426. The laser welding beams 422-426 may be delivered simultaneously or in any suitable order and may generally trace along, within, and/or across the fiducial markers 402-408 to create laser welds between the optical components 410-416 and the top surface 418. The laser welding beams 422-426 may be scanned, for example, as shown by arrow 428, to generate laser welds, such as a linear weld.

Each optical component 410-416 may be aligned and held (e.g., against the substrate 400 top surface 418) using robotic arms and/or manually operated tools terminated with manipulators. For example, grippers 430, 432 may squeeze (e.g., as indicated by arrow 434) the optical component 410 and rotate, slide, or otherwise manipulate the component 410 to position the component 410 in alignment with the corresponding fiducial marker 408, indicated by arrow 436. For example, the positional sensors described herein may capture real-time image data of the component 410 as it is maneuvered into place relative to the fiducial marker 408. The controller and any corresponding processors may analyze this image data (e.g., via edge detection or similar image analysis techniques) to determine the position and orientation of the component 410 relative to the fiducial marker 408. The controller and/or other processors may further determine and transmit control instructions that cause the grippers 430, 432 to position/orient the component 410 relative to the fiducial marker 408 more accurately.

More generally, the optical components 410-416 are configured to process an optical beam (not shown). These optical components 410-416 may include various types of optical components configured to redirect, split, combine and/or otherwise process light. For example, the optical components 410-416 (and others described herein) may include optical fibers, mirrors, lenses, prisms, beam splitters, waveguides, diffraction gratings, photonic crystals, filters, polarizers, resonant cavities, and/or any other suitable components or combinations thereof. In some examples, the optical components 410-416 may include optical components that generate light (e.g., lasers, light emitting diodes, etc.), detect light, and/or convert light to other energy (e.g., detectors, photocells, etc.).

Additionally, the optical components 410-416 and/or others described herein may include various types of materials. Components used to pass laser light for welding during the laser welding process illustrated in FIG. 4A may include material(s) that are substantially transparent for the wavelength of the laser light, such as glass, crystal (e.g., semiconductor), or ceramic for laser light having a wavelength of about 1030 nm, although other wavelengths may be used, such as 780 nm. The optical components 410-416, which may or may not be used to pass laser welding light during the laser welding process, may generally be transparent for light processed as part of the optical system partially comprised of the optical components 410-416, such as light having a wavelength of about 780 nm, 1030 nm, 1300 nm or any other suitable wavelength.

In one example, the substrate 400, the optical components 410-416, and/or the pedestal 438 used to support the optical component 416 may each include glass (e.g., fused silica), crystal, or ceramic. Components that are not used to pass laser light for welding during the laser welding process of FIG. 4A may include a material that is opaque for the laser light wavelength (e.g., a metal or other material having low coefficients of thermal expansion). In some examples, such as when laser welding light is not transmitted through the optical component during the laser welding process, an optical component may include silicon (e.g., a silicon lens), which is opaque at the welding laser wavelength but not opaque for the light (e.g., which may also be laser light) processed by the optical system comprised of the optical components 410-416 and/or other optical components not illustrated in FIG. 4A.

FIG. 4B is a top-down view of an optical component alignment on a substrate 440. In some examples, the optical component alignment illustrated in FIG. 4B is a top-down view of the optical component alignment illustrated in FIG. 4A. The optical component alignment includes three optical components 442, 444, and 446 that have been accurately positioned on the substrate 440 surface using the corresponding fiducial markers and laser welded to the surface. The optical component alignment further includes another optical component 448 that is actively being aligned with the corresponding fiducial marker 450, as indicated by the arrows 452, 454, and 456.

In particular, one or more of the manipulator components (e.g., grippers 430, 432) described herein may be actively adjusting the location of the optical component 448 to more accurately align the component 448 with the corresponding fiducial marker 450 prior to laser welding. One or more position sensors (e.g., position sensors 214, 216) may capture image data of the optical component 448 and the corresponding fiducial marker 450, and a controller (e.g., controller 218) and/or other suitable processor may analyze the image data using one or more machine vision techniques to determine how the optical component 448 should be manipulated/adjusted to more accurately align the optical component 448 with the corresponding fiducial marker 450.

Generally, the machine vision techniques performed by the controller and/or other suitable processor(s) may analyze the image data captured by one or more position sensors to determine control instructions based on one or more image characteristics of one or both of the optical component 448 and the corresponding fiducial marker 450. These machine vision techniques may include, for example, edge detection, contour detection, feature extraction, thresholding, and/or any other suitable technique or combinations thereof. As one example, the machine vision techniques include analyzing one or more edges of the optical component 448, as represented in the pixel data of the captured images, relative to one or more corresponding edges of the corresponding fiducial marker 450 to determine distances between these edges for aligning the optical component 448. In another example, the machine vision techniques include determining that the optical component 448 is within a threshold distance of the corresponding fiducial marker 450.

As a result of these machine vision techniques, the controller may generate and transmit control instructions to the manipulator component(s) that instruct the manipulator component to adjust the position and/or orientation of the optical component 448 through three-dimensional (3D) translation (x, y, and z coordinates) and/or 3D rotation (roll, pitch, and yaw angles), three of which are illustrated in FIG. 4B (e.g., x, y, and yaw). The optical component 448 illustrated in FIG. 4B is misaligned relative to the corresponding fiducial marker 450 in each of the x-coordinate position, the y-coordinate position, and the yaw angle. The control instructions received at the manipulator components described herein may indicate as much and may cause the manipulator components to adjust the x-coordinate position (indicated by arrow 452), the y-coordinate position (indicated by arrow 454), and the yaw angle (indicated by arrow 456) of the optical component 448. In this manner, the techniques described herein enable laser welding systems to align optical components on a substrate (e.g., 440) more accurately prior to laser welding by leveraging highly accurate image analysis techniques in combination with highly accurate/precise fiducial writing methods.

These advantages are further highlighted by the optical alignment illustrated in FIG. 4C, which is a cross-sectional view of the optical component alignment from FIG. 4B. FIG. 4C generally illustrates the optical component 448 being actively aligned with a fiducial marker included as part of the set of fiducial markers 460, as indicated by the arrows 462, 464. One or more of the manipulator components (e.g., grippers 430, 432) described herein may be actively adjusting the location of the optical component 448 to align the component 448 more accurately with the substrate 440 component surface 466 prior to laser welding. One or more position sensors (e.g., position sensors 214, 216) may capture depth data of the optical component 448 and the component surface 466, and a controller (e.g., controller 218) and/or other suitable processor may analyze the depth data to determine how the optical component 448 should be manipulated/adjusted to align the optical component 448 more accurately with the component surface 466.

Generally, the depth data analysis utilized herein includes determining a distance of the optical component 448 from the component surface 466 and determining an angle slope of the optical component 448 relative to the component surface 466 in y-coordinates and z-coordinates. For example, the controller and/or other suitable processor(s) may analyze the depth data to determine that the optical component 448 is approximately 15 mm from the component surface 466 and that the optical component 448 has a roll angle of approximately 3° and pitch angle of approximately 5° relative to the component surface 466. Accordingly, the controller may determine control instructions to move the optical component 448 approximately 15 mm towards the component surface 466 (e.g., in a negative z direction, as illustrated in FIG. 4C) and adjusting the roll angle and pitch angle (e.g., rotating) of the optical component by approximately 3° and 5°, respectively.

As a result of these depth data analysis techniques, the controller may generate and transmit control instructions to the manipulator component(s) that instruct the manipulator component to adjust the position and/or orientation of the optical component 448 through 3D translation and/or 3D rotation, three of which are illustrated in FIG. 4C (e.g., z, roll, and pitch). The optical component 448 illustrated in FIG. 4B is misaligned relative to the component surface 466 in the z-coordinate position and the pitch angle. While not illustrated in FIG. 4C, the optical component 448 may also be misaligned relative to the component surface 466 in the roll angle (e.g., along the x-axis). The control instructions received at the manipulator components described herein may indicate as much and may cause the manipulator components to adjust the z-coordinate position (indicated by arrow 462), the pitch angle (indicated by arrow 464), and the roll angle (not shown) of the optical component 448. In this manner, the techniques described herein enable laser welding systems to align optical components on a substrate (e.g., 440) more accurately prior to laser welding by leveraging highly accurate depth data analysis techniques in combination with the highly accurate image analysis techniques described herein (e.g., in reference to FIG. 4B).

Moreover, FIG. 4C illustrates the three optical components 442, 444, and 446 and further illustrates an optical component 468 that is mounted and/or otherwise affixed to the optical component 442. Namely, the optical component 468 is attached to the component surface 466 by way of the optical component 442. In the embodiment illustrated in FIG. 4C, the optical component 442 is a pedestal and/or may further include a carrier/subcarrier and the optical component 468 may be an active optical element that is attached to the pedestal/carrier/subcarrier.

The optical component 468 may first be attached to the pedestal 442 by laser welding or another suitable attachment technique (e.g., adhesive, friction fit, spring, etc.).

The pedestal 442 may then, in turn, be attached (e.g., by laser welding or another suitable attachment technique) to the component surface 466. It should be noted that an assembly process for such components 442/468 may include attaching the pedestal 442 to the component surface 466 before, after, or contemporaneously with attaching the optical component 468 to the pedestal 442.

Generally, the pedestal 442 may provide one or more additional degrees of freedom when positioning the optical component 468 during assembly of the optical system. The pedestal 442 may provide for position adjustment along the z-axis to ensure that light from the optical component 468 is directed through the optical component 444 to the optical component 446. To provide the z-axis adjustment, the pedestal 442 may, for example, have the optical component 468 disposed eccentrically at or within it, and the z-axis adjustment of the optical component 468 may then result from rotating a subcarrier (not shown) (e.g., roll axis adjustment) disposed on the pedestal 442. Furthermore, the pedestal 442 and/or other subcarriers disposed thereon may provide for a rotational adjustment in the xy-plane (e.g., yaw axis adjustment) for the optical component 468, and/or translational position adjustments in the xy-plane.

In some examples, during use of the optical system, no light may pass through the pedestal 442. In other words, the pedestal 442 may help position the optical component 468 during assembly of the optical system but need not provide any optical functions (e.g., process light) during use of the completed optical system. In other examples, the pedestal 442 may provide one or more additional optical functions during use of the completed optical system or may pass light without altering or substantially altering the light. As a result of being attached to the component surface 466 via the pedestal 442, the optical component 468 may be spaced apart from the component surface 466 (e.g., along the z-axis), or otherwise aligned.

In certain embodiments, a fiducial marker written into a substrate may not represent an exact size, shape, or aligned position of the corresponding optical component(s). The optical component may then be misaligned and/or otherwise repositioned relative to the fiducial marker, for example, to tune the optical system. These adjustments may be facilitated by a pedestal (e.g., pedestal 442) configured to provide multi-axis adjustments and/or may be facilitated by a robotic arm/manipulator and/or a multi-dimensional stage (e.g., six-dimensional stage). To further illustrated these intentional misalignments/repositioning of optical components relative to the corresponding fiducial marker(s), FIG. 4D is a top-down view of an example optical system aligned using fiducial markers on a substrate 470, with several optical components 472, 474 being misaligned with their respective fiducial markers 476, 478 to tune the example optical system.

The example optical system disposed on the substrate 470 in FIG. 4D is generally configured to process an optical beam represented as beam sections 480, 482, and 484. To that end, the example optical system includes optical components 472, 474, 486, and 488.

The optical components 472, 474 may initially be positioned on the substrate 470 in alignment with the corresponding fiducial markers 476, 478. When tuning the optical system, however, each of the optical components 472, 474 may be intentionally misaligned with the respective fiducial markers 476, 478 to tune the overall optical system.

More generally, the optical system illustrated in FIG. 4D may be a fiber-to-fiber coupling system where optical components 486, 488 are angled fibers and optical components 472, 474 are collimating/focusing lenses. A divergent beam section 480 exiting the angled fiber optical component 486 is collimated by the lens optical component 472 to form a collimated beam section 482. The collimated beam section 482 is focused into the converging beam section 484 by the lens optical component 474 and coupled into the angled fiber optical component 488. Of course, the direction of the beam may be reversed, with the light exiting from the angled fiber optical component 488 and coupling into the angled fiber optical component 486, and additional components (e.g., polarizers, filters, gratings, apertures, modulators, switches, etc.) may be placed in the collimated beam section 482 to perform additional light processing.

Regardless, the assembly process for aligning and attaching the optical system may need to be performed in an active manner, relying on feedback from measurements of the light processed by the optical components 472, 474, 486, and 488. The components 472, 474 may initially be positioned on the substrate 470 in response to determining that the components are generally aligned (e.g., within a threshold/tolerance distance) with the corresponding fiducial markers 476, 478. In one example, a system (e.g., laser welding system 200) for performing the assembly may reposition the optical component 472 (illustrated by arrow 490) to misalign the component 472 relative to the corresponding fiducial marker 476 in response to an image generated by a camera (e.g., the alignment camera 212). The image generated by the camera may indicate a beamwidth or a pointing direction of the collimated segment of the beam 482. Additionally, or alternatively, the assembly system may determine that the optical component 472 or other components (e.g., 474, 486, 488) should be repositioned (or rotated) to misalign the component 472 relative to the corresponding fiducial marker 476 along any suitable axes (e.g., x, y, or z-axes) or rotated along any suitable axes (e.g., yaw, roll, or pitch angles). If subsequent image data generated by the alignment camera indicates that the beamwidth and/or pointing direction of the collimated beam segment 482 is adequate, then the assembly systems described herein may attach (e.g., laser weld) the optical component 472 to the component surface of the substrate 470 in the misaligned position relative to the corresponding fiducial marker 476 illustrated in FIG. 4D.

As another example, during the active assembly process, a power meter (not shown) that is configured to measure power collected by the fiber optical component 486 from the fiber optical component 488 may be used to generate indications of alignment. After the fiber optical component 486 is attached to the substrate 470, the assembly systems described herein may determine that the optical component 474 should be rotated (illustrated by arrow 492) relative to the corresponding fiducial marker 478 based at least in part on data from the power meter. Following the rotational adjustment, the assembly system may analyze data from the power meter to determine whether adequate power is collected by the fiber optical component 486, and if so, the optical component 474 may be attached (e.g., laser welded) to a component surface of the substrate 470 in the misaligned position relative to the corresponding fiducial marker 478 illustrated in FIG. 4D.

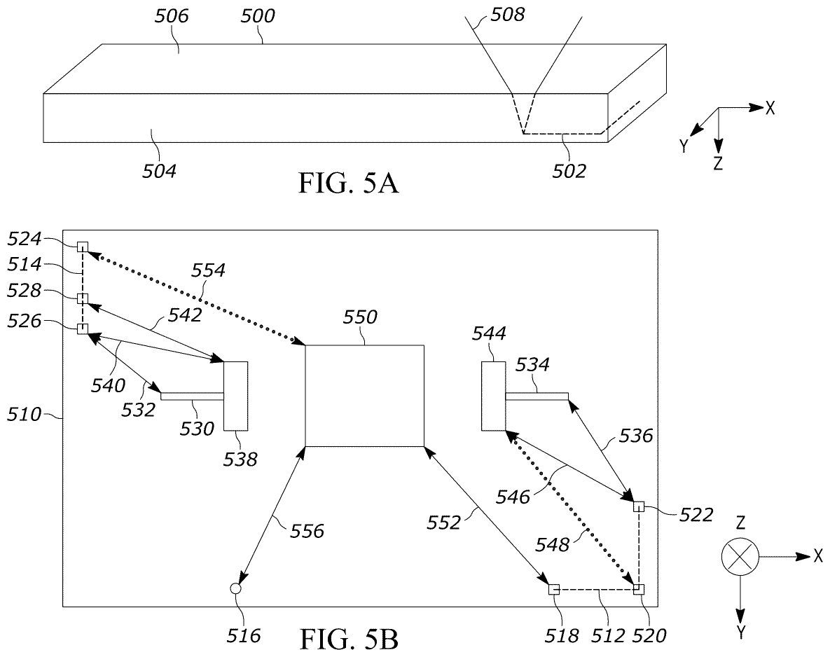

FIG. 5A schematically illustrates a datum writing process for aligning optical components on a substrate 500. Generally, the datum writing process illustrated in FIG. 5A includes writing a datum 502 in the substrate 500 to define a starting point for the coordinate system (e.g., x-y coordinates) used to align optical components on component surface 504 of the substrate 500. For example, the datum 502 illustrated in FIG. 5A is two lines forming a corner near a corner of the substrate 500, and the datum 502 is positioned within the substrate near the component surface 504 of the substrate 500. However, it should be appreciated that the datum 502 may comprise any suitable set of written markers, such as a single line, a circle, or any other suitable shape of any suitable size, and may also be positioned at any suitable x-y location within/on the substrate 500 (e.g., top-left corner, bottom-right corner, middle of an edge, center of the substrate 500). Further, the datum 502 may be written at any suitable depth within the substrate, such as near the component surface 504 (e.g., within several mm), near the back surface 506, approximately in a middle of the substrate 500 in between the two surfaces 504, 506, and/or at any other suitable depth.

The datum writing process illustrated in FIG. 5A includes a system similar to the fiducial writing systems described herein (e.g., fiducial writing system 100) writing both of the lines comprising the datum 502 in x and y directions using a USP laser (indicated by the writing laser 508). The system may also monitor the writing of the datum 502 in real-time to register coordinate associations between the pixel values corresponding to the datum 502. For example, the writing systems described herein may designate the corner of the datum 502 as the x-y coordinate position (0,0) for all subsequent positioning of optical components by a laser welding/assembly system. Alternatively, the writing systems may designate any suitable location of the datum 502 as the origin point (e.g., (0,0)) for use in subsequent optical system assembly.

For example, as illustrated in FIG. 5B, the writing systems described herein may register the x-y coordinate distances associated with various datum written in a substrate 510. FIG. 5B is a top-down view of an optical component alignment using various datum 512, 514, and 516 written in multiple different locations of a substrate 510. The writing systems described herein may measure the distances from a starting point or edge of the various datum 512, 514, and 516 in x and y coordinates to an end point or opposite edge of the respective datum 512, 514, and 516 to calibrate the position sensor (e.g., camera) pixel size. While illustrated in FIG. 5B as multiple datum 512, 514, 516 simultaneously present in the substrate 510, this is for the purposes of discussion only. It should be appreciated that the substrate 510 may include a single datum for performing all subsequent measurements, two datum, or any suitable number of datum.

For example, to calibrate the imaging devices used as part of the assembly systems described herein, the writing systems may write the datum 512, 514 as a known length of line using a USP laser and measure the number of pixels between the two endpoints of the lines. The writing system may measure the distances between the point 518 and the point 520, between the point 520 and the point 522, and/or between the point 518 and the point 522 (e.g., the triangle hypotenuse) to determine the correlation between pixel size the physical distance on the substrate 510. Similarly, the writing system may evaluate the distance between the point 524 and point 526 of datum 514. In certain embodiments, the writing systems described herein may utilize these calibrations to enable the assembly systems to measure distances from any suitable point on the datum, such as point 528 of datum 514.

Additionally, or alternatively, the systems described herein may write datum in shapes other than lines, such as the circular datum 516. To calibrate the imaging systems to enable accurate distance measurements during the assembly process, the writing system may evaluate the number of pixels comprising the diameter, radius, circumference, and/or any other suitable known measurement of the datum 516. Accordingly, the systems described herein may write datum of any suitable shape, size, and/or in any suitable x-y-z position within the substrate 510 and may correspondingly calibrate the imaging systems to ensure accurate measurements when assembling optical systems and/or performing any other suitable tasks.

When the writing system writes one or more of the datum 512, 514, 516 illustrated in FIG. 5B and calibrates the position sensors accordingly, the assembly systems described herein may utilize the datum 512, 514, 516 to position and attach optical components accurately. The assembly systems described herein may measure the x-y position of optical components based on the distance of the component (e.g., an edge of the component) from a single point of a single datum. For example, the assembly systems described herein may position a first optical component 530 on the substrate 510 and may measure the x-y coordinate position of the first optical component 530 using the datum 514, and more specifically, based on the distance of the component 530 from the point 526 (represented by line 532) of the datum 514. Similarly, the assembly systems described herein may position a second optical component 534 on the substrate 510 and may measure the x-y coordinate position of the second optical component 534 using the datum 512, and more specifically, based on the distance of the component 534 from the point 522 (represented by line 536) of the datum 512.

In certain embodiments, the assembly systems described herein may measure the x-y position of optical components based on the distance of the component (e.g., an edge of the component) from multiple points of one or more datum. For example, the assembly systems described herein may position a third optical component 538 on the substrate 510 and may measure the x-y coordinate position of the third optical component 538 using the datum 514, and more specifically, based on the distance of the component 538 from the point 526 (represented by line 540) and the point 528 (represented by line 542) of the datum 514.

Similarly, the assembly systems described herein may position a fourth optical component 544 on the substrate 510 and may measure the x-y coordinate position of the fourth optical component 544 using the datum 512, and more specifically, based on the distance of the component 544 from the point 522 (represented by line 546) and/or from the point 520 (represented by line 548) of the datum 512. In this example, the assembly systems may optionally measure the distance from the point 520 to the fourth optical component 544 if, for example, the assembly systems are configured to determine multiple measurements of the x-y coordinates for optical components prior to attachment to the substrate 510 for redundancy purposes.

As another example, the assembly systems described herein may position a fifth optical component 550 on the substrate 510 and may measure the x-y coordinate position of the fifth optical component 550 using multiple datum 512, 514, and 516. The assembly system may determine a first distance of the component 550 from the point 518 (represented by line 552) of the datum 512, a second distance of the component 550 from the point 524 (represented by line 554) of the datum 514, and/or a third distance of the component 550 from the datum 516 (represented by line 556). Each measurement may indicate the respective distance of a particular edge or corner of the optical component 550 from the respective datum 512-516. For example, the distance measurement 552 may identify the distance from the point 518 to the component 550 bottom-right corner, and correspondingly, the x-y coordinates of the bottom-right corner.

In some examples, one or more of the multiple distance measurements may be sufficient to determine, and thereby accurately adjust, the x-y coordinate position of an optical component. For example, the distance measurement 552 from the datum 512 and the distance measurement 556 from the datum 516 may be sufficient to adjust the x-y coordinates of the fifth optical component 550, such that the distance measurement 554 may be unnecessary. In any event, it should be appreciated that the assembly systems described herein may utilize the datum written by the writing systems described herein to position optical components in any suitable manner, such as determining distances to one or more edges or other relevant features of the optical components from one or more positions/points of the one or more datum.

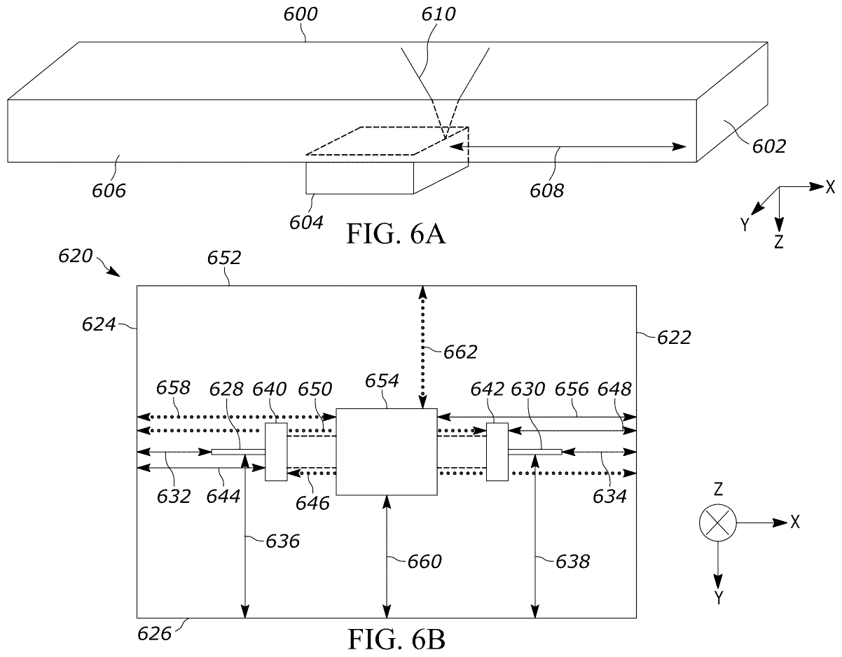

In certain embodiments, one or more edges of the substrate are the datum used by the assembly systems described herein. For example, FIG. 6A schematically illustrates an optical component alignment and welding process using an edge of the substrate 600 as a datum. In the example of FIG. 6A, the writing systems and/or the assembly systems described herein may register (e.g., capture image data of) one or more edges of the substrate 600, such as edge 602, to thereafter calibrate the imaging systems based on distances (e.g., in pixel numbers) from the known edge(s).

Before the assembly systems described herein begin laser welding an optical component 604 to a component surface 606 of the substrate 600, the assembly systems may determine a distance (represented by line 608) of the component 604 from the known substrate edge(s) (e.g., edge 602). When the assembly systems determine that the optical component 604 is adequately positioned on the component surface 606 of the substrate (e.g., within threshold distance from substrate 600 edge 602, etc.), then the assembly systems may laser weld (represented by welding laser 610) the optical component 604 to the component surface 606 of the substrate 600.

In certain scenarios, the writing systems and/or assembly systems described herein may register and/or otherwise utilize multiple substrate 600 edges to determine the x-y coordinate positions of an optical component being positioned and attached to the component surface 606. Such a multi-edge measurement process is generally illustrated in FIG. 6B, which is a top-down view of an alignment of multiple optical components using one or more edges of the substrate 620 as the datum.

Generally, the multi-edge alignment process illustrated in FIG. 6B includes the writing/assembly systems described herein capturing image data and calibrating the distance measurements based on the known dimensions of one or more of the substrate 620 edges. Namely, the systems described herein may capture image data of a first edge 622, a second edge 624, and a third edge 626, and may calibrate the imaging systems/sensors based on the known dimensions (e.g., length) of one or more of the edges 622-626. Based on this calibration, the assembly systems described herein may measure the distances from any optical component positioned on a surface of the substrate 620 to position (e.g., in x-y coordinates) the component on the surface accurately.

The systems described herein may generally measure the distance between an optical component and one or more proximate edges of the substrate 620 when determining x-y coordinate positioning to, for example, reduce potential errors stemming from inaccurate calibrations. For example, the assembly systems described herein may position a first optical component 628 and a second optical component 630 on the substrate 620 surface. The systems may measure the distance (represented by line 632) from the second edge 624 to the first optical component 628 and may measure the distance (represented by line 634) from the first edge 622 to the second optical component 630 to ensure accurate x-coordinate positioning of both components 628, 630. Similarly, the assembly systems may measure the distance (represented by line 636) from the third edge 626 to the first optical component 628 and may measure the distance (represented by line 638) from the third edge 626 to the second optical component 630 to ensure accurate y-coordinate positioning of both components 628, 630.

In certain scenarios, the systems described herein may leverage distance measurements made from multiple edges. For example, the assembly systems described herein may position a third optical component 640 and a fourth optical component 642 on the substrate 620 surface. The systems may measure the distance (represented by line 644) from the second edge 624 to the third optical component 640 and may measure the distance (represented by line 646) from the first edge 622 to the third optical component 640 to ensure accurate x-coordinate positioning of the third optical component 640. The assembly systems may also measure the distance (represented by line 648) from the first edge 622 to the fourth optical component 642 and may measure the distance (represented by line 650) from the second edge 624 to the fourth optical component 642 to ensure accurate x-coordinate positioning of the fourth optical component 642. It should be appreciated that the assembly systems described herein may also measure the distance from the third and fourth optical components 640, 642 from one of the third edge 626 and/or a fourth edge 652 to determine accurate y-coordinate positioning of the optical components 640, 642.

The systems described herein may also determine x-y coordinate positioning for each individual optical component based on distances from each edge. For example, the assembly systems described herein may position a fifth optical component 654 on the substrate 620 surface. The systems may measure the distance (represented by line 656) from the first edge 622 to the fifth optical component 654 and may measure the distance (represented by line 658) from the second edge 624 to the fifth optical component 654 to ensure accurate x-coordinate positioning of the fifth optical component 654. Moreover, the systems may measure the distance (represented by line 660) from the third edge 626 to the fifth optical component 654 and may measure the distance (represented by line 662) from the fourth edge 652 to the fifth optical component 654 to ensure accurate y-coordinate positioning of the fifth optical component 654.

In certain embodiments, the alignment performed in FIG. 6B may be performed based on defining any of the corners of the substrate 620 as an origin point (e.g., (0,0)), from which, all distances on the substrate 620 may be measured.

It should be appreciated that the alignment performed in reference to any of FIGS. 3A-6B may utilize one or more of the machine vision techniques described herein and/or any other suitable techniques or combinations thereof.

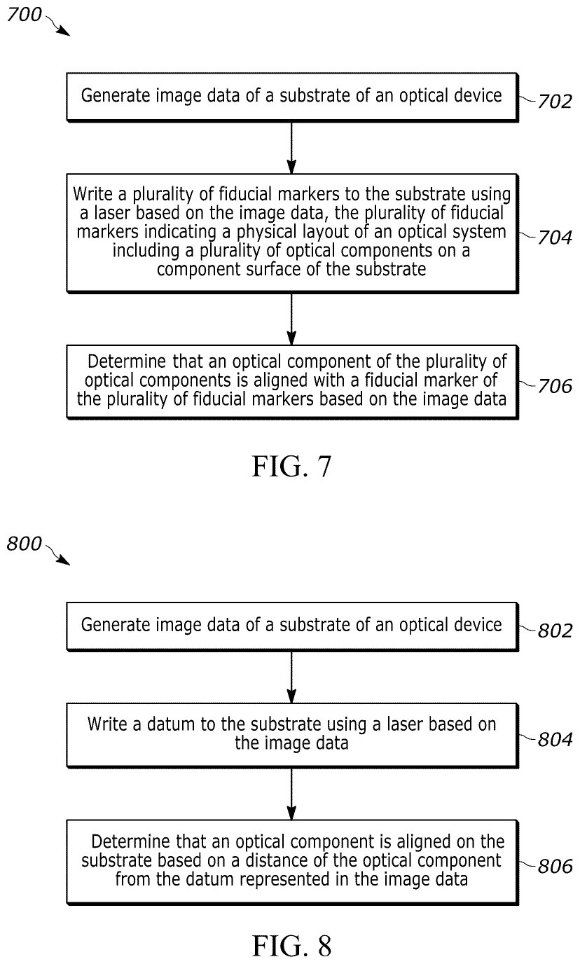

FIG. 7 is a flow chart of an example method 700 for writing fiducial markers indicating a physical layout of an optical system in a substrate to align optical components on the substrate. The method 700 may use any of the systems described herein, such as the fiducial writing system 100 and/or the laser welding system 200.

At block 702, the method 700 includes generating image data of a substrate of the optical device. The method 700 further includes writing a plurality of fiducial markers to the substrate using a laser based on the image data (block 704). The plurality of fiducial markers may indicate a physical layout of an optical system including a plurality of optical components on a component surface of the substrate. The method 700 may further include determining that an optical component of the plurality of optical components is aligned with a fiducial marker of the plurality of fiducial markers based on the image data (block 706).

In some embodiments, the method 700 further includes attaching the optical component to the component surface of the substrate while the optical component is aligned with the fiducial marker.

In some embodiments, the optical component is attached to the component surface of the substrate using the laser.

In some embodiments, determining that the optical component is aligned with the fiducial marker further includes determining that the optical component is within a threshold distance of the fiducial marker on the component surface of the substrate.

In some embodiments, the method 700 further includes aligning the optical component to the fiducial by comparing at least one edge of the optical component to at least one edge of the fiducial.

In some embodiments, the method 700 further includes adjusting a location of an optical component to tune the optical system after attaching one or more optical components of the plurality of optical components to the component surface.

In some embodiments, the fiducial marker indicates where the optical component is placed prior to adjustment for tuning the optical system.

In some embodiments, the plurality of fiducial markers has a different refractive index than the substrate surrounding the plurality of fiducial markers.

In some embodiments, the substrate includes glass and the plurality of fiducial markers are defined by melted portions of the glass.

In some embodiments, each optical component of the plurality of optical components is welded to the component surface using a USP laser.

In some embodiments, each fiducial marker of the plurality of fiducial markers is positioned at most approximately 2 millimeters (mm) from the component surface.

In some embodiments, each fiducial marker of the plurality of fiducial markers is positioned substantially at a middle of the substrate between the component surface and a back surface of the substrate.

In some embodiments, each fiducial marker of the plurality of fiducial markers is positioned at a first distance from the component surface that is greater than a second distance of the plurality of fiducial markers from a back surface of the substrate.

In some embodiments, the plurality of optical components includes a pedestal attached to the component surface; and an active optical element attached to the pedestal.

In some embodiments, the plurality of optical components includes at least one of: (i) an optical fiber, (ii) a mirror, (iii) a lens, (iv) a prism, (v) a beam splitter, (vi) a waveguide, (vii) a diffraction grating, or (viii) a photonic crystal.

In some embodiments, at least one optical component of the plurality of optical components is misaligned with a respective fiducial marker when attached to the component surface to tune the optical system. In some embodiments, the at least one optical component is a lens or a mirror.

In some embodiments, each fiducial marker of the plurality of fiducial markers represents an outline of a corresponding optical component of the plurality of optical components.

In some embodiments, each fiducial marker of the plurality of fiducial markers represents a portion of an outline of a corresponding optical component of the plurality of optical components.

In some embodiments, the plurality of fiducial markers includes one or more lines connecting fiducial markers.

In some embodiments, the laser is a USP laser, and writing the plurality of fiducial markers further includes emitting laser pulses that change a refractive index of the substrate. In some embodiments, the method 700 further includes adjusting a position of the USP laser relative to the substrate to focus the USP laser between the component surface of the substrate and a back surface of the substrate for fiducial writing, wherein the back surface is opposite the component surface.

In some embodiments, the method 700 further includes determining that each optical component of the plurality of optical components is within a threshold distance using edge detection on pixel values within the image data.

In some embodiments, the method 700 further includes manipulating, by a manipulator assembly, at least one optical component of the plurality of optical components to create physical contact between the optical component and the substrate.

In some embodiments, the manipulator assembly includes a multi-axis robotic manipulator or a six-dimensional stage. In these embodiments, the manipulator assembly may be a collection/group of stages that collectively achieve six degrees of freedom.

In some embodiments, the method 700 further includes measuring, by a depth sensor, (1) a distance of at least one optical component of the plurality of optical components and (2) an angle of the at least one optical component relative to the component surface of the substrate.

In some embodiments, the method 700 further includes adjusting a pitch value or a roll value of the optical component relative to the component surface based on the distance or the angle of the at least one optical component relative to the component surface.

FIG. 8 is a flow chart of an example method 800 for writing datum in a substrate to align optical components on the substrate. The method 800 may use any of the systems described herein, such as the fiducial writing system 100 and/or the laser welding system 200.

At block 802, the method 800 includes generating image data of a substrate of the optical device. The method 800 further includes writing a datum to the substrate using a laser based on the image data (block 804). The method 800 may further include determining that an optical component (e.g., of a plurality of optical components) is aligned on the substrate based on a distance of the optical component from the datum represented in the image data (block 806).

In some embodiments, the method 800 further includes attaching the optical component to the component surface of the substrate when the distance satisfies a threshold value (e.g., a distance threshold).

In some embodiments, the optical component is attached to the component surface of the substrate using the laser.

In some embodiments, the method 800 further includes adjusting a location of an optical component to tune the optical system after attaching one or more optical components to the component surface.

In some embodiments, the datum has a different refractive index than the substrate surrounding the datum.

In some embodiments, the substrate includes glass and the datum is defined by melted portions of the glass.

In some embodiments, each optical component of a plurality of optical components is welded to the component surface using a USP laser.

In some embodiments, the datum is positioned at most approximately 2 millimeters (mm) from the component surface.

In some embodiments, the datum is positioned substantially at a middle of the substrate between the component surface and a back surface of the substrate.

In some embodiments, the datum is positioned at a first distance from the component surface that is greater than a second distance of the datum from a back surface of the substrate.

In some embodiments, the datum includes a plurality of datum that are each positioned at different locations within the substrate. For example, a first datum may be positioned at a first corner of the substrate that is defined by a junction between a first edge and a second edge of the substrate, and a second datum may be positioned along a third edge of the substrate that is different from the first edge and the second edge of the substrate.

In some embodiments, the plurality of optical components includes a pedestal attached to the component surface; and an active optical element attached to the pedestal.

In some embodiments, the plurality of optical components includes at least one of: (i) an optical fiber, (ii) a mirror, (iii) a lens, (iv) a prism, (v) a beam splitter, (vi) a waveguide, (vii) a diffraction grating, or (viii) a photonic crystal.

In some embodiments, at least one optical component of the plurality of optical components has a distance value from the datum (e.g., in x-y coordinates) that fails to satisfy the distance threshold when attached to the component surface to tune the optical system. In some embodiments, the at least one optical component is a lens or a mirror.

In some embodiments, the datum is a single line, a plurality of lines (e.g., a portion of a rectangle, square, a set of parallel/perpendicular lines), a single shape (e.g., a circle), or a plurality of shapes (e.g., a plurality of circles).

In some embodiments, the datum includes a plurality of datum and one or more lines connecting one or more of the plurality of datum.

In some embodiments, the laser is a USP laser, and writing the datum further includes emitting laser pulses that change a refractive index of the substrate. In some embodiments, the method 800 further includes adjusting a position of the USP laser relative to the substrate to focus the USP laser between the component surface of the substrate and a back surface of the substrate for datum writing, wherein the back surface is opposite the component surface.

In some embodiments, the method 800 further includes determining that each optical component of the plurality of optical components is within a threshold distance using edge detection on pixel values within the image data.

In some embodiments, the method 800 further includes manipulating, by a manipulator assembly, at least one optical component of the plurality of optical components to create physical contact between the optical component and the substrate.

In some embodiments, the manipulator assembly includes a multi-axis robotic manipulator or a six-dimensional stage.

In some embodiments, the method 800 further includes measuring, by a depth sensor, (1) a distance of at least one optical component of the plurality of optical components and (2) an angle of the at least one optical component relative to the component surface of the substrate.

In some embodiments, the method 800 further includes adjusting a pitch value or a roll value of the optical component relative to the component surface based on the distance or the angle of the at least one optical component relative to the component surface.

### Aspects

Aspect 1. An optical device, comprising: a substrate including: a component surface; a back surface opposite the component surface; and a plurality of fiducial markers within the substrate between the component surface and back surface; and an optical system configured to process light, the optical system including a plurality of optical components on the component surface of the substrate, each optical component being aligned to a respective fiducial marker.

Aspect 2. The optical device of aspect 1, wherein the plurality of fiducial markers has a different refractive index than the substrate surrounding the plurality of fiducial markers.

Aspect 3. The optical device of aspect 1 or 2, wherein the substrate includes glass and the plurality of fiducial markers are defined by melted portions of the glass.

Aspect 4. The optical device of any of aspects 1 through 3, wherein each optical component of the plurality of optical components is welded to the component surface using a ultra-short pulse (USP) laser.

Aspect 5. The optical device of any of aspects 1 through 4, wherein each fiducial marker of the plurality of fiducial markers is positioned at most approximately 2 millimeters (mm) from the component surface.

Aspect 6. The optical device of any of aspects 1 through 5, wherein each fiducial marker of the plurality of fiducial markers is positioned substantially at a middle of the substrate between the component surface and back surface.

Aspect 7. The optical device of any of aspects 1 through 6, wherein each fiducial marker of the plurality of fiducial markers is positioned at a first distance from the component surface that is greater than a second distance of the plurality of fiducial markers from the back surface.

Aspect 8. The optical device of any of aspects 1 through 7, wherein the plurality of optical components includes: a pedestal attached to the component surface; and an active optical element attached to the pedestal.

Aspect 9. The optical device of any of aspects 1 through 8, wherein the plurality of optical components includes at least one of: (i) an optical fiber, (ii) a mirror, (iii) a lens, (iv) a prism, (v) a beam splitter, (vi) a waveguide, (vii) a diffraction grating, or (viii) a photonic crystal.

Aspect 10. The optical device of any of aspects 1 through 9, wherein at least one optical component of the plurality of optical components is misaligned with a respective fiducial marker when attached to the component surface to tune the optical system.

Aspect 11. The optical device of aspect 10, wherein the at least one optical component is a lens or a mirror.

Aspect 12. The optical device of any of aspects 1 through 11, wherein each fiducial marker of the plurality of fiducial markers represents an outline of a corresponding optical component of the plurality of optical components.

Aspect 13. The optical device of any of aspects 1 through 12, wherein each fiducial marker of the plurality of fiducial markers represents a portion of an outline of a corresponding optical component of the plurality of optical components.

Aspect 14. The optical device of any of aspects 1 through 13, wherein the plurality of fiducial markers includes one or more lines connecting fiducial markers.

Aspect 15. The optical device of any of aspects 1 through 14, wherein each optical component of the plurality of optical components is attached to the component surface of the substrate while the optical component is aligned with the respective fiducial marker.

Aspect 16. The optical device of any of aspects 1 through 15, wherein each optical component of the plurality of optical components is within a threshold distance of the respective fiducial marker on the component surface of the substrate.

Aspect 17. The optical device of any of aspects 1 through 16, wherein each optical component of the plurality of optical components is aligned to the respective fiducial marker by comparing at least one edge of the optical component to at least one edge of the respective fiducial marker.

Aspect 18. The optical device of any of aspects 1 through 17, wherein at least one optical component of the plurality of optical components is adjusted to tune the optical system after attaching one or more optical components of the plurality of optical components to the component surface.

Aspect 19. The optical device of any of aspects 1 through 18, wherein a USP laser writes the plurality of fiducial markers by emitting laser pulses that change a refractive index of the substrate.

Aspect 20. The optical device of aspect 19, wherein the emitted pulses from the USP laser have a plurality of amplitudes to focus the USP laser between the component surface of the substrate and the back surface of the substrate for fiducial writing.

Aspect 21. The optical device of any of aspects 1 through 20, wherein each optical component of the plurality of optical components is aligned within a threshold distance of the respective fiducial marker using edge detection on pixel values within image data including the optical component and the respective fiducial marker.

Aspect 22. The optical device of any of aspects 1 through 21, wherein each optical component of the plurality of optical components is aligned with the respective fiducial marker using a manipulator assembly configured to manipulate the optical components to create physical contact between the optical components and the substrate.

Aspect 23. The optical device of aspect 22, wherein the manipulator assembly includes a multi-axis robotic manipulator or a six-dimensional stage.

Aspect 24. The optical device of any of aspects 1 through 23, wherein each optical component of the plurality of optical components is aligned with the respective fiducial marker using a depth sensor configured to measure (i) a distance of the optical components and (ii) an angle of the optical components relative to the component surface of the substrate.

Aspect 25. The optical device of aspect 24, wherein at least one optical component of the plurality of optical components is aligned with the respective fiducial marker by adjusting a pitch value or a roll value of the at least one optical component relative to the component surface based on the distance or the angle of the at least one optical component relative to the component surface.

Aspect 26. A method for manufacturing an optical device, comprising: generating image data of a substrate of the optical device; writing a plurality of fiducial markers to the substrate using a laser based on the image data, the plurality of fiducial markers indicating a physical layout of an optical system including a plurality of optical components on a component surface of the substrate; and determining that an optical component of the plurality of optical components is aligned with a fiducial marker of the plurality of fiducial markers based on the image data.

Aspect 27. The method of aspect 26, further comprising: attaching the optical component to the component surface of the substrate while the optical component is aligned with the fiducial marker.

Aspect 28. The method of aspect 27, wherein the optical component is attached to the component surface of the substrate using the laser.

Aspect 29. The method of any of claims aspect 26-28, wherein determining that the optical component is aligned with the fiducial marker further comprises: determining that the optical component is within a threshold distance of the fiducial marker on the component surface of the substrate.

Aspect 30. The method of any of claims aspect 26-29, further comprising: aligning the optical component to the fiducial by comparing at least one edge of the optical component to at least one edge of the fiducial.

Aspect 31. The method of any of claims aspect 26-30, further comprising: adjusting a location of an optical component to tune the optical system after attaching one or more optical components of the plurality of optical components to the component surface.

Aspect 32. The method of aspect 31, wherein the fiducial marker indicates where the optical component is placed prior to adjustment for tuning the optical system.

Aspect 33. The method of any of aspects 26 through 32, wherein the plurality of fiducial markers has a different refractive index than the substrate surrounding the plurality of fiducial markers.

Aspect 34. The method of any of aspects 26 through 33, wherein the substrate includes glass and the plurality of fiducial markers are defined by melted portions of the glass.

Aspect 35. The method of any of aspects 26 through 34, wherein each optical component of the plurality of optical components is welded to the component surface using a USP laser.

Aspect 36. The method of any of aspects 26 through 35, wherein each fiducial marker of the plurality of fiducial markers is positioned at most approximately 2 millimeters (mm) from the component surface.

Aspect 37. The method of any of aspects 26 through 36, wherein each fiducial marker of the plurality of fiducial markers is positioned substantially at a middle of the substrate between the component surface and a back surface of the substrate.

Aspect 38. The method of any of aspects 26 through 37, wherein each fiducial marker of the plurality of fiducial markers is positioned at a first distance from the component surface that is greater than a second distance of the plurality of fiducial markers from a back surface of the substrate.

Aspect 39. The method of any of aspects 26 through 38, wherein the plurality of optical components includes: a pedestal attached to the component surface; and an active optical element attached to the pedestal.

Aspect 40. The method of any of aspects 26 through 39, wherein the plurality of optical components includes at least one of: (i) an optical fiber, (ii) a mirror, (iii) a lens, (iv) a prism, (v) a beam splitter, (vi) a waveguide, (vii) a diffraction grating, or (viii) a photonic crystal.

Aspect 41. The method of any of aspects 26 through 40, wherein at least one optical component of the plurality of optical components is misaligned with a respective fiducial marker when attached to the component surface to tune the optical system.

Aspect 42. The method of any of aspect 41, wherein the at least one optical component is a lens or a mirror.

Aspect 43. The method of any of aspects 26 through 42, wherein each fiducial marker of the plurality of fiducial markers represents an outline of a corresponding optical component of the plurality of optical components.

Aspect 44. The method of any of aspects 26 through 43, wherein each fiducial marker of the plurality of fiducial markers represents a portion of an outline of a corresponding optical component of the plurality of optical components.

Aspect 45. The method of any of aspects 26 through 44, wherein the plurality of fiducial markers includes one or more lines connecting fiducial markers.

Aspect 46. The method of any of aspects 26 through 45, wherein the laser is a USP laser, and writing the plurality of fiducial markers further comprises: emitting laser pulses that change a refractive index of the substrate.

Aspect 47. The method of aspect 46, further comprising: adjusting a position of the USP laser relative to the substrate to focus the USP laser between the component surface of the substrate and a back surface of the substrate for fiducial writing, wherein the back surface is opposite the component surface.

Aspect 48. The method of any of aspects 26 through 47, further comprising: determining that each optical component of the plurality of optical components is within a threshold distance using edge detection on pixel values within the image data.

Aspect 49. The method of any of aspects 26 through 48, further comprising: manipulating, by a manipulator assembly, at least one optical component of the plurality of optical components to create physical contact between the optical component and the substrate.

Aspect 50. The method of aspect 49, wherein the manipulator assembly includes a multi-axis robotic manipulator or a six-dimensional stage.

Aspect 51. The method of any of aspects 26 through 50, further comprising: measuring, by a depth sensor, (1) a distance of at least one optical component of the plurality of optical components and (2) an angle of the at least one optical component relative to the component surface of the substrate.

Aspect 52. The method of aspect 51, further comprising: adjusting a pitch value or a roll value of the optical component relative to the component surface based on the distance or the angle of the at least one optical component relative to the component surface.

Aspect 53. A system for aligning an optical device, the system comprising: a laser for writing a plurality of fiducial markers to a substrate, the plurality of fiducial markers indicating a physical layout of an optical system including a plurality of optical components on a component surface of the substrate; an imaging system configured to generate image data of the substrate; and a controller configured to: cause the laser to write the plurality of fiducial markers to the substrate based on the image data; and determine that an optical component of the plurality of optical components is aligned with a fiducial marker of the plurality of fiducial markers based on the image data.

Aspect 54. The system of aspect 53, wherein the laser is a USP laser, and the controller is further configured to cause the laser to write the plurality of fiducial markers by: emitting laser pulses that change a refractive index of the substrate.

Aspect 55. The system of aspect 54, wherein the controller is further configured to: adjust a position of the USP laser relative to the substrate to focus the USP laser between the component surface of the substrate and a back surface of the substrate for fiducial writing, wherein the back surface is opposite the component surface.

Aspect 56. The system of any of aspects 53 through 55, wherein the controller is further configured to determine that the optical component is aligned with the fiducial marker by: determining that the optical component is within a threshold distance of the fiducial marker within the image data.

Aspect 57. The system of aspect 56, wherein the controller is configured to determine that the optical component is within the threshold distance using edge detection on pixel values within the image data.

Aspect 58. The system of any of aspects 53 through 57, further comprising: a manipulator assembly configured to manipulate an optical component to create physical contact between the optical component and the substrate.

Aspect 59. The system of aspect 58, wherein the manipulator assembly includes a multi-axis robotic manipulator or a six-dimensional stage.

Aspect 60. The system of any of aspects 53 through 59, further comprising: a depth sensor configured to measure (1) a distance of the optical component and (2) an angle of the optical component relative to the component surface of the substrate.

Aspect 61. The system of aspect 60, wherein the controller is further configured to: adjust a pitch value or a roll value of the optical component relative to the component surface based on the distance or the angle of the optical component relative to the component surface.

Aspect 62. The system of any of aspects 53 through 61, wherein the controller is further configured to: control attaching the optical component to the component surface using a USP laser.

Aspect 63. The system of any of aspects 53 through 62, wherein the plurality of fiducial markers has a different refractive index than the substrate surrounding the plurality of fiducial markers.

Aspect 64. The system of any of aspects 53 through 63, wherein the substrate includes glass and the plurality of fiducial markers are defined by melted portions of the glass.

Aspect 65. The system of any of aspects 53 through 64, wherein each optical component of the plurality of optical components is welded to the component surface using a USP laser.

Aspect 66. The system of any of aspects 53 through 65, wherein each fiducial marker of the plurality of fiducial markers is positioned at most approximately 2 millimeters (mm) from the component surface.

Aspect 67. The system of any of aspects 53 through 66, wherein each fiducial marker of the plurality of fiducial markers is positioned substantially at a middle of the substrate between the component surface and a back surface of the substrate.

Aspect 68. The system of any of aspects 53 through 67, wherein each fiducial marker of the plurality of fiducial markers is positioned at a first distance from the component surface that is greater than a second distance of the plurality of fiducial markers from a back surface of the substrate.

Aspect 69. The system of any of aspects 53 through 68, wherein the plurality of optical components includes: a pedestal attached to the component surface; and an active optical element attached to the pedestal.

Aspect 70. The system of any of aspects 53 through 69, wherein the plurality of optical components includes at least one of: (i) an optical fiber, (ii) a mirror, (iii) a lens, (iv) a prism, (v) a beam splitter, (vi) a waveguide, (vii) a diffraction grating, or (viii) a photonic crystal.

Aspect 71. The system of any of aspects 53 through 70, wherein at least one optical component of the plurality of optical components is misaligned with a respective fiducial marker when attached to the component surface to tune the optical system.

Aspect 72. The system of aspect 71, wherein the at least one optical component is a lens or a mirror.

Aspect 73. The system of any of aspects 53 through 72, wherein each fiducial marker of the plurality of fiducial markers represents an outline of a corresponding optical component of the plurality of optical components.

Aspect 74. The system of any of aspects 53 through 73, wherein each fiducial marker of the plurality of fiducial markers represents a portion of an outline of a corresponding optical component of the plurality of optical components.

Aspect 75. The system of any of aspects 53 through 74, wherein the plurality of fiducial markers includes one or more lines connecting fiducial markers.

Aspect 76. The system of any of aspects 53 through 75, wherein each optical component of the plurality of optical components is attached to the component surface of the substrate while the optical component is aligned with the respective fiducial marker.

Aspect 77. The system of any of aspects 53 through 76, wherein each optical component of the plurality of optical components is within a threshold distance of the respective fiducial marker on the component surface of the substrate.

Aspect 78. The system of any of aspects 53 through 77, wherein each optical component of the plurality of optical components is aligned to the respective fiducial marker by comparing at least one edge of the optical component to at least one edge of the respective fiducial marker.

Aspect 79. The system of any of aspects 53 through 78, wherein at least one optical component of the plurality of optical components is adjusted to tune the optical system after attaching one or more optical components of the plurality of optical components to the component surface.

Aspect 80. The system of aspect 79, wherein the fiducial marker indicates where the optical component is placed prior to adjustment for tuning the optical system.

### Additional Considerations

In the description, specific details have been set forth describing some examples. Numerous specific details are set forth to provide a thorough understanding of the examples. It will be apparent, however, to one skilled in the art that some examples may be practiced without some or all of these specific details. The specific examples disclosed herein are meant to be illustrative but not limiting. One skilled in the art may realize other elements that, although not specifically described here, are within the scope of this disclosure.

Any alterations and further modifications to the described assemblies, apparatuses, methods, and any further application of the principles of the present disclosure are fully contemplated as would normally occur to one skilled in the art to which the disclosure relates. To avoid needless descriptive repetition, one or more components or actions described in accordance with one illustrative example may be used or omitted as applicable from other illustrative examples. For the sake of brevity, the numerous iterations of these combinations will not be described separately. For simplicity, in some instances the same reference numbers are used throughout the drawings to refer to the same or like parts.

Additionally, one or more elements in examples of this disclosure, including operations of methods, may be implemented in software to execute on a processor of a computer system such as a control processing system. When implemented in software, the elements of the examples of the present disclosure are essentially the code segments to perform the necessary tasks. The program or code segments may be stored in a processor readable storage medium (e.g., a non-transitory storage medium) or device that may have been downloaded by way of a computer data signal embodied in a subcarrier wave over a transmission medium or a communication link. The processor readable storage device may include any medium that may store information including an optical medium, semiconductor medium, and magnetic medium. Processor readable storage device examples include an electronic circuit, a semiconductor device, a semiconductor memory device, a read only memory (ROM), a flash memory, an erasable programmable read only memory (EPROM); a floppy diskette, a CD-ROM, an optical disk, a hard disk, or other storage device. The code segments may be downloaded via computer networks such as the Internet, Intranet, etc. Any of a wide variety of centralized or distributed data processing architectures may be employed. Programmed instructions may be implemented as a number of separate programs or subroutines, or they may be integrated into a number of other aspects of the systems described herein. In some examples, the control system may support wireless communication protocols such as Bluetooth, Infrared Data Association (IrDA), HomeRF, IEEE 802.11, Digital Enhanced Cordless Telecommunications (DECT), ultra-wideband (UWB), ZigBee, and Wireless Telemetry.

While certain example examples of the present disclosure have been described and shown in the accompanying drawings, it is to be understood that such examples are merely illustrative of and not restrictive to the broad disclosed concepts, and that the examples of the present disclosure not be limited to the specific constructions and arrangements shown and described, since various other modifications may occur to those ordinarily skilled in the art.

1. An optical device, comprising:
a substrate including:
a component surface;
a back surface opposite the component surface; and
a plurality of fiducial markers within the substrate between the component surface and back surface; and
an optical system configured to process light, the optical system including a plurality of optical components on the component surface of the substrate, each optical component being aligned to a respective fiducial marker.

2. The optical device of claim 1, wherein the plurality of fiducial markers has a different refractive index than the substrate surrounding the plurality of fiducial markers.

3. The optical device of claim 1, wherein the substrate includes glass and the plurality of fiducial markers are defined by melted portions of the glass.

4. The optical device of any of claim 1, wherein each optical component of the plurality of optical components is welded to the component surface using a ultra-short pulse (USP) laser.

5. The optical device of any of claim 1, wherein each fiducial marker of the plurality of fiducial markers is positioned at least one of:
(i) at most approximately 2 millimeters (mm) from the component surface, (ii) substantially at a middle of the substrate between the component surface and back surface, or (iii), at a first distance from the component surface that is greater than a second distance of the plurality of fiducial markers from the back surface.

6. (canceled)

7. (canceled)

8. The optical device of claim 1, wherein the plurality of optical components includes at least one of: (i) a pedestal attached to the component surface; (ii) an active optical element attached to the pedestal (iii) an optical fiber, (iv) a mirror, (v) a lens, (vi) a prism, (vii) a beam splitter, (viii) a waveguide, (ix) a diffraction grating, or (x) a photonic crystal.

9. (canceled)

10. The optical device of any of claim 1, wherein at least one optical component of the plurality of optical components is misaligned with a respective fiducial marker when attached to the component surface to tune the optical system, and
wherein the at least one optical component is a lens or a mirror.

11. (canceled)

12. The optical device of claim 1, wherein each fiducial marker of the plurality of fiducial markers represents an outline of a corresponding optical component of the plurality of optical components, or
wherein each fiducial marker of the plurality of fiducial markers represents a portion of an outline of a corresponding optical component of the plurality of optical components.

13. (canceled)

14. The optical device of claim 1, wherein the plurality of fiducial markers includes one or more lines connecting fiducial markers.

15. The optical device of claim 1, wherein each optical component of the plurality of optical components is at least one of: (i) attached to the component surface of the substrate while the optical component is aligned with the respective fiducial marker, (ii) within a threshold distance of the respective fiducial marker on the component surface of the substrate, or (iii) aligned to the respective fiducial marker by comparing at least one edge of the optical component to at least one edge of the respective fiducial marker.

16. (canceled)

17. (canceled)

18. The optical device of claim 1, wherein at least one optical component of the plurality of optical components is adjusted to tune the optical system after attaching one or more optical components of the plurality of optical components to the component surface.

19. The optical device of claim 1, wherein a USP laser writes the plurality of fiducial markers by emitting laser pulses that change a refractive index of the substrate, and
wherein the emitted pulses from the USP laser have a plurality of amplitudes to focus the USP laser between the component surface of the substrate and the back surface of the substrate for fiducial writing.

20. (canceled)

21. The optical device of any of claim 1, wherein each optical component of the plurality of optical components is aligned within a threshold distance of the respective fiducial marker using edge detection on pixel values within image data including the optical component and the respective fiducial marker.

22. The optical device of any of claim 1, wherein each optical component of the plurality of optical components is aligned with the respective fiducial marker using a manipulator assembly configured to manipulate the optical components to create physical contact between the optical components and the substrate, and
wherein the manipulator assembly includes a multi-axis robotic manipulator or a six-dimensional stage.

23. (canceled)

24. The optical device of claim 1, wherein each optical component of the plurality of optical components is aligned with the respective fiducial marker using a depth sensor configured to measure (i) a distance of the optical components and (ii) an angle of the optical components relative to the component surface of the substrate, and
wherein at least one optical component of the plurality of optical components is aligned with the respective fiducial marker by adjusting a pitch value or a roll value of the at least one optical component relative to the component surface based on the distance or the angle of the at least one optical component relative to the component surface.

25. (canceled)

26. A method for manufacturing an optical device, comprising:
generating image data of a substrate of the optical device;
writing a plurality of fiducial markers to the substrate using a laser based on the image data, the plurality of fiducial markers indicating a physical layout of an optical system including a plurality of optical components on a component surface of the substrate; and
determining that an optical component of the plurality of optical components is aligned with a fiducial marker of the plurality of fiducial markers based on the image data.

27. The method of claim 26, further comprising:
attaching the optical component to the component surface of the substrate while the optical component is aligned with the fiducial marker, and
wherein the optical component is attached to the component surface of the substrate using the laser.

28. (canceled)

29. The method of claim 26, wherein determining that the optical component is aligned with the fiducial marker further comprises:
determining that the optical component is within a threshold distance of the fiducial marker on the component surface of the substrate.

30. The method of claim 26, further comprising:
aligning the optical component to the fiducial by comparing at least one edge of the optical component to at least one edge of the fiducial, or
adjusting a location of an optical component to tune the optical system after attaching one or more optical components of the plurality of optical components to the component surface.

31.-52. (canceled)

53. A system for aligning an optical device, the system comprising:
a laser for writing a plurality of fiducial markers to a substrate, the plurality of fiducial markers indicating a physical layout of an optical system including a plurality of optical components on a component surface of the substrate;
an imaging system configured to generate image data of the substrate; and
a controller configured to:
cause the laser to write the plurality of fiducial markers to the substrate based on the image data; and
determine that an optical component of the plurality of optical components is aligned with a fiducial marker of the plurality of fiducial markers based on the image data.

54.-80. (canceled)
